(19) United States
(12) Patent Application Publication
(10) Pub. No.: US 2009/0249222 A1
(43) Pub. Date: Oct. 1, 2009

(54) SYSTEM AND METHOD FOR SIMULTANEOUS MEDIA PRESENTATION

(75) Inventors: Geoffrey R. Schmidt, San Francisco, CA (US); Nicholas C. Martin, Berkeley, CA (US)

Correspondence Address: WOLF GREENFIELD & SACKS, P.C., 600 ATLANTIC AVENUE, BOSTON, MA, 02210-2206, US

(73) Assignee: Square Products Corporation, Cambridge, MA (US)

(21) Appl. No.: 12/410,410

(22) Filed: Mar. 24, 2009

Related U.S. Application Data
(60) Provisional application No. 61/039,331, filed on Mar. 25, 2008.

(51) Int. Cl. G06F 15/16; G06F 3/048; G06F 1/12

(52) U.S. Cl. 715/751; 713/400

(57) ABSTRACT

Described herein are systems and methods for presenting content to a plurality of users at a plurality of computers. Presenting content may comprise presenting media content (e.g., playing media content) such as audio or video content—including music; audio books; image slideshows; movies, television programs, video clips, and other video content; and any other suitable audio and/or visual content—at the plurality of computers to create a shared media experience (e.g., a shared listening/viewing experience) among the plurality of users. In some embodiments, one or more techniques may be applied to ensure that presentation of the content is performed substantially simultaneously (also referred to as synchronously) at each of the computers to ensure that each of the users is experiencing the same content at the same time.

### RELATED APPLICATIONS

This application claims priority under 35 U.S.C. §119(e) to U.S. Provisional Application Ser. No. 61/039,331, entitled “System and method for simultaneous media presentation,” filed on Mar. 25, 2008, which is incorporated herein by reference in its entirety.

### SUMMARY

In one embodiment of the invention, there is provided a method of sharing media content for simultaneous presentation to users at two or more computers. The method comprises receiving a play schedule listing a plurality of units of media content, assembling a sequence of media content according to the play schedule at each of the two or more computers, and synchronizing presentation of the sequence of media content at the two or more computers.

In some implementations of this embodiment of the invention, synchronizing presentation of the stream of media content may comprise synchronizing playback clocks at each of the two or more computers.

In another embodiment of the invention, there is provided, in a system comprising a plurality of users each having a library of media content, a method of facilitating shared presentation of content units among at least a subset of the plurality of users. The subset comprises first and second users. The method comprises creating a play schedule including at least one media content unit obtained from the library of a third user and simultaneously presenting media associated with the play schedule for the first and second users.

In a further embodiment of the invention, there is provided at least one computer-readable storage medium encoded with computer-executable instructions that, when executed by a computer, carry out a method of sharing media content for simultaneous presentation to users at two or more computers. The method comprises receiving a play schedule listing a plurality of units of media content, assembling a sequence of media content according to the play schedule, presenting the sequence of media content at the computer, and maintaining synchronicity of presentation of the sequence with at least one other computer.

In another embodiment of the invention, there is provided at least one computer-readable storage medium encoded with computer-executable instructions that, when executed by a computer in a system comprising a plurality of users each having a library of media content, carry out a method of facilitating shared presentation of content units among at least a subset of the plurality of users, where the subset comprises first and second users. The method comprises creating a play schedule including at least one media content unit obtained from the library of a third user, presenting media associated with the play schedule for the first user, and during the presenting of the media associated with the play schedule, adjusting presentation of the media to the first user to ensure the media is presented synchronously with presentation of the media to a second user at a remote computer.

In a further embodiment there is provided an apparatus for use in a computer system comprising a plurality of client computers, where the apparatus is adapted to operate as a client computer to present media content synchronously with at least one other client computer. The apparatus comprises at least one processor adapted to receive a play schedule listing a plurality of units of media content, assemble a sequence of media content according to the play schedule, and present the sequence of media content at the computer; and maintain synchronicity of presentation of the sequence with at least one other computer.

In one embodiment of the invention, there is provided an apparatus for use in a computer system comprising a plurality of client computers each having a library of media content, where the apparatus is adapted to operate as a client computer to present media content to a first user synchronously with at least one other client computer presenting the media content to a second user. The apparatus comprises at least one processor adapted to create a play schedule including at least one media content unit obtained from the library of a third user of a third client computer, present media associated with the play schedule for the first user, and, during the presenting of the media associated with the play schedule, adjust presentation of the media to the first user to ensure the media is presented synchronously with presentation of the media to the second user at the at least one other client computer.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of one exemplary computer system in which some techniques described herein may be implemented;

FIG. 2 is a flowchart of an exemplary process for simultaneously presenting media content at a plurality of computers in accordance with some embodiments of the invention;

FIG. 3 is a flowchart of one exemplary process for maintaining synchronicity of presentation of media content at a plurality of computers in accordance with some embodiments of the invention;

FIG. 4 is a flowchart of one exemplary process for updating a play schedule to present media content in a different manner in accordance with some embodiments of the invention;

FIG. 5 is a flowchart of one exemplary process for receiving an updated play schedule and presenting media content in a different manner according to the updated play schedule in accordance with some embodiments of the invention;

FIG. 6 is a flowchart of one exemplary process for adding media content to a play schedule by accessing a media library stored on at least one other computer in accordance with some embodiments of the invention;

FIG. 7 is a block diagram of one exemplary computing device that may be used to implement some of the techniques described herein;

FIG. 8A is a screenshot of one exemplary user interface for a software application that may be used on a client computer to implement some of the techniques for social media presentation described herein;

FIG. 8B is a screenshot of one exemplary user interface for a software application that may be used on a client computer to implement some of the techniques for multi-room social media presentation described herein; and

FIG. 8C is a screenshot of one exemplary user interface for a software application that may be used on a client computer to implement some of the techniques for multi-room social media presentation described herein.

### DETAILED DESCRIPTION

Some embodiments of the invention are directed to systems for presenting content to a plurality of users at a plurality of computers. Presenting content may comprise presenting media content (e.g., playing media content) such as audio or video content—including music; audio books; image slideshows; movies, television programs, video clips, and other video content; and any other suitable audio and/or visual content—at the plurality of computers to create a shared media experience (e.g., a shared listening and/or viewing experience) among the plurality of users. In some embodiments, one or more techniques may be applied to ensure that presentation of the content is performed substantially simultaneously (also referred to as synchronously) at each of the computers to ensure that each of the users is experiencing the same content at the same time.

It should be appreciated that “simultaneous” or “synchronous” presentation may include differences in precise presentations, but the differences may be within a threshold (examples of which are discussed below) that is sufficiently small to result in a satisfactory shared listening/viewing experience. Also, while some embodiments are directed to simultaneous presentation, it should be appreciated that some techniques described herein are not limited in this respect, and can be used in other types of information sharing systems (e.g., media sharing systems).

General overviews of various aspects of the invention are presented below, and are followed by descriptions, in greater detail, of various exemplary implementations that provide illustrations of how some of the aspects and embodiments may be implemented. It should be appreciated, however, that the techniques described herein are not limited to being implemented in the manner described in these exemplary implementations. Furthermore, while various aspects of the invention are described herein (it should be appreciated that such references to the accompanying documents as well as this introduction) as being employed together in a system configuration, it should be appreciated that the techniques described herein are not limited to use in any particular combination or combinations, as any of the aspects of the invention described herein each may be implemented alone or in any combination of two or more.

In one exemplary embodiment, a plurality of users of computers may engage in a simultaneous media presentation (e.g., one in which a shared listening/viewing experience is created) by each connecting to a server (or multiple servers) from which content is being provided. The server(s) may provide to each connected computer a play schedule listing a sequence of media content to be presented to the plurality of users and time information that enables the computers to determine when each of the units of media content is to be presented. In such an embodiment, some or all of the users engaging in the session may be permitted to edit the play schedule by, for example, adding content to or removing content from the play schedule or by reordering the content in the schedule. Instructions regarding changes to the play schedule made by one or more users may be transmitted to the server, which may then provide an updated play schedule to each of the computers. Alternatively, such instructions may be transmitted to each of the other computers by the computer whose user made the change, may be transmitted according to a hybrid of these two approaches, or may be transmitted in any other suitable manner. When a user at one computer makes a change to the play schedule, this change will be reflected in the play schedules presented to each of the other users substantially immediately (i.e., once the change has been distributed through the network of computers), such that there is distributed control over the play schedule. Instructions to change the play schedule may be exchanged in any suitable manner, including, but not limited to, using any of the exemplary techniques discussed herein.

In some, but not necessarily all, embodiments wherein users' computers connect to one or more server(s) which may distribute one or more play schedule(s), the server(s) may also act to provide data for the content in the play schedule to all or some of the computers. In some such embodiments, some process in the system (e.g., a daemon process operating on the server) may determine (e.g., from the current time and the play schedule indicating the time, or in other ways) what content should be distributed to the users at any particular time; may retrieve the content (e.g., from files, streams, database entries, or other suitable sources local and/or remote to the server); and transmit the data to the appropriate computers. In some implementations, a play schedule may include an offset indicating at what point presentation of the content is to begin, such as by indicating a number of bytes or a percent of the file to skip (e.g., not present to the first kilobyte or the first 10 percent to users) or a time of the file at which presentation should begin (e.g., not present the first 10 seconds of the file to users). In this manner, a play schedule may be adapted to start presentation of a unit of content at a point other than the beginning of the content such that, for example, a song may be started partway through or at what a user considers to be a good part.

Content to be presented to users may be retrieved from any suitable source. For example, in some embodiments the content may be available on local storage media of the users' computers. Alternatively or additionally, the content may be available on a network-accessible storage media, such as a storage media of the server(s). In some embodiments, the server(s) may additionally provide a content storage service such that some or all of the users may have a “library” of content stored on and accessible via the server, and content to be included in the session may be selected from such a library. In some such embodiments, the content in the library may have been uploaded by users and/or may have been associated with users from a larger library of content maintained by the server(s). Such an implementation may be used in some situations where the server(s) hosts an online music store or online music service to which a user may have a paid or unpaid subscription, and the user can purchase, lease, or select songs to be placed into the user's library on the server and made available to the user and to other users including those in the session. Alternatively, such an implementation may be used when users can upload content to the server(s) for storage and later use. It should be appreciated, however, that any suitable storage medium may be used as a source of content information in embodiments of the invention.

In some embodiments of the invention, a user is able to add his or her own content to a play schedule (e.g., a song owned by the user) (e.g., from the user's local computer, on-line locker of the type described above, or elsewhere), and may be able to add content associated with other users, regardless of the source, to the play schedule for presentation in the session.

In some, but not all, embodiments of the invention, a size of a user group in a play session may be limited to a certain size or demographic—for example, a group of less than 80 to 100 users, or a group consisting only of users identified as socially connected in some way—to ensure that presentation of content does not violate the rights of any right-holders in the content (e.g., copyright holders for a song).

A user may use any suitable software to connect to the server(s) and/or other clients in any suitable manner. For example, in one embodiment a user may access the server(s) and/or other clients through a web browser according to a user interface implemented as one or more web pages implementing, for example, HTML, JavaScript and/or Adobe Flash, while in another embodiment a user may access the server through a stand-alone client application having a user interface. Any suitable user interface may be implemented by embodiments of the invention. A user interface may be structured in any suitable manner. One illustrative user interface may comprise a listing of content to be presented to a user (e.g., according to the play schedule) and provide a user with controls by which to control the content or ordering of the listing. A user interface may also comprise a display for information related to content being presented (e.g., title/artist/album information for a song currently playing) and a progress indicator for the content. A user interface may also comprise a listing of other users participating in the session, and may provide the ability to send text messages to one or more of the other users. Examples of user interfaces that may be implemented in some embodiments are also described below, but it should be appreciated that these user interfaces are merely illustrative of the type that may be implemented and that all embodiments are not limited to working with these or any other particular types of user interfaces. For example, a user interface can be employed that includes any combination of any of the features described herein.

In some embodiments, one or more techniques may be employed for maintaining the synchronization of computers in presenting the media data. While any suitable technique may be employed by embodiments of the invention, including any one or more of the exemplary techniques discussed below, one illustrative embodiment may maintain synchronization through using the central server to throttle the users' computers by only releasing a certain amount of data at a time. Additionally or alternatively, embodiments of the invention may maintain synchronization by using clocks on each of the users' computers to track presentation of content to users and periodically comparing this time to a central time checked by all computers (e.g., a time on the server, a time provided by an official source such as U.S. Atomic Time or a time server, or any other suitable clock), and then presenting content according to the play schedule and to the synchronized clock. Applicants have appreciated that the local clocks on computers may differ slightly in maintaining a time base, and that the clocks used by some presentation devices (e.g., digital-to-analog conversion (DAC) clocks in sound cards in personal computers) may differ more drastically such that content is presented at different rates (i.e., a song may be played slightly faster on one computer than on another, leading the first computer to start playing a next song before the other computer finishes playing the first song). Thus, in some embodiments, maintaining synchronization includes more frequent checks or additional techniques, discussed further below, to enforce synchronization.

One exemplary embodiment of a system for synchronous content presentation is described below that implements a server. It should be appreciated, however, that this embodiment is merely illustrative, as embodiments of the invention which implement a server are not limited to operating in the manner outlined below, as alternate embodiments which implement a server may operate in any suitable manner.

In another embodiment, central server(s) may not be necessary to establish and/or maintain the session. In such an embodiment, each of the users may exchange information (e.g., data and instructions) directly with one another to maintain the play schedule and present the media data. In some embodiments of the invention without a server, each of the computers may be responsible for assembling a stream of content to present to a user from information received from one or more local or remote sources. For example, each computer may receive a play schedule (either from a server, if one is used, or from another computer), then retrieve content from the content sources, including computers, according to the play schedule, and present the content to its user. In some cases, when a computer operating according to these embodiments receives a play schedule indicating that a first unit of content has already begun being presented to other users in the session (i.e., the user of the computer has joined mid-song), then the computer may calculate a particular location in the received content to begin presenting (e.g., calculate a byte location in a song file at which presentation should start). In some implementations, calculating the location may comprise retrieving (or receiving), from the source of the content, a seek table for the content listing byte offsets associated with time offsets in the content (e.g., 100 kilobytes corresponds to 10 seconds). An entry in the seek table closest to the desired time may then be identified, and then the desired time located by, for example, scanning ahead a number of bytes proportional to the decompressed size of the content, or proportional to the size of compression frames, and the byte offset seen in the seek table, or in any other suitable manner.

Synchronizing presentation may be done in such an embodiment in any suitable manner. First, it should be appreciated that synchronization may refer to keeping the computers exactly in sync with one another or keeping computers within a threshold synchronization range determined by the application of the techniques. For example, while an offset of a full minute may in some applications be disastrous for creating a simultaneously listening/viewing experience, in other applications it may be acceptable. Accordingly, a threshold synchronization range may be any value suitable to the application, examples of which include a minute, 10 seconds, 1-2 seconds, less than 50 milliseconds, or any other value.

Any suitable synchronization technique, including any one or more of the illustrative techniques discussed herein, may be implemented by embodiments of the invention. For example, DAC clocks (or other presentation clock) having different clock rates may be synchronized through selectively providing content to the DAC for presentation to the user, such that if the DAC is consuming content faster than it should be presentation may be kept in sync by only providing content to the DAC at the rate it should be consumed. If the DAC is consuming content slower than it should be (e.g., it is playing a song slower than normal) then, in some embodiments of the invention, the content may be resampled such it is adapted to be presented at a faster-than-normal rate in a way that when it is presented on the slow DAC it is presented at a normal rate. Additionally or alternatively, DAC clock drift may be compensated for between units of content by removing a last portion of the unit of content or a first portion of a unit of content (e.g., removing the last or first second of content, to compensate for a one-second offset from true) by inserting or removing gaps between content (e.g., if a song is playing faster than normal, a small gap may be inserted between the end of the song and the beginning of the next), or in other suitable ways.

Seek tables, as described above, may also be used in maintaining synchronization. For example, if a larger delay is experienced for any reason (e.g., a portion of the data for the content was not received for some time and that data could not be presented to the user) then the seek table may be used to find a place in the content at which to resume synchronized presentation. Of course, seek tables can be used to maintain synchronization in other contexts are well.

As will be discussed in further detail below, in some, but not necessarily all, embodiments a delay on one computer may result in a change in control (e.g., a change to the play schedule) in other computers to keep content presentation in the session synchronized.

Play schedules may be used in some embodiments of the invention, regardless of whether a server is implemented, to pass information regarding a sequence of content and a time for presentation to users and computers. A play schedule may be structured in any suitable manner and comprise any suitable information. Some exemplary techniques for implementing play schedules in some embodiments of the invention for some illustrative applications are described herein, but it should be appreciated that these structures and contents are merely illustrative.

In some embodiments of the invention, a play schedule may be used to indicate information regarding units of content to be presented in a session and times at which to present them. A play schedule may include, for example, a start time for a presentation session, a listing of contents to be presented and a presentation length for each of unit of content, such that a particular time for presentation of a particular content unit may be calculated from the session start time and the cumulative presentation lengths for previous units of content. Alternatively, a play schedule may indicate a start time for each unit of content. A play schedule may further comprise any information that may be useful and/or necessary in a session, such as an identifier for at least one source of content to be presented (e.g., a pointer, URL, or other reference to a local or remote location from which data for the content may be retrieved).

Play schedules may be received by a computer at any suitable time, such as when a user joins a session, and updated play schedules may be exchanged between computers and the server (if one is implemented) at any suitable time, such as when an update is made to the play schedule (e.g., content is added, removed, or reordered).

In some embodiments of the invention, a play schedule may be implemented as a queue in which a content unit at the top of the listing is presented and then removed from the listing. Users may be able to add, subtract, and reorder the contents in any suitable manner, but in these embodiments the first content unit is presented to the user and then removed from the listing after it is presented or played. Exemplary techniques for organizing and managing a playlist according to a queue model are discussed herein, though it should be appreciated that these techniques are merely illustrative, as the embodiments of the invention that employ a queue may be implemented in any suitable way. In addition, a queue is merely an example of a play schedule that can be used with the techniques described herein, as the play schedule may operate in any suitable manner.

In some embodiments of the invention, such as those that operate a play schedule according to a queue model, when the queue becomes empty one or more selection processes may be implemented to choose content to be added to the play schedule. Content may be selected in any suitable manner, including using any of the exemplary techniques discussed herein, such as (1) randomly; (2) determining preference information for users in any suitable manner and selecting content according to the preference information; (3) determining a demographic of users and selecting content that will appeal to the demographic and/or earn revenue for providing particular content to the demographic; or in any other suitable manner according to any suitable process.

In some, but not necessarily all, embodiments of the invention, chat functionality may be integrated into the session to allow a user to send a text message to one or more other users. In some exemplary embodiments, as described herein, information regarding a content unit being presented at the time of the text message may be inserted into the chat display, such that if users engage in a chat regarding the content it may be clear to others (e.g., those viewing a record of the chat later) what content is being discussed. This information may be any suitable identifier for the content, including, for example, source, title, and/or author data for the content, and may be inserted into the chat record at any suitable time, including when the content is first presented or when a text message is first received following presentation of the content.

In some embodiments of the invention, a user is only able to participate in one session at a time, while in alternative embodiments of the invention a user may participate in two or more sessions at a time. In other embodiments, tow or more classes of participants may be defined; e.g., an “active participant” may be capable of receiving and being presented with content for the session and being able to interact with the session by sending text messages and manipulating the play schedule, while a “passive participant” may view the status of the session (e.g., view the play schedule and/or chat) but may have limited ability to interact with the session (e.g., may not be able to perform some of the functions such as chat or edit the play schedule) and may or may not be presented with the content. The embodiments that allow a user to participate in multiple sessions may be combined with the embodiments that define multiple classes of participants in any suitable manner. For example, in some such embodiments, a user may be able to identify only one session to be an active participant in and may be automatically categorized as a passive participant in others, while in alternative embodiments of the invention a user may be able to freely set a status between active and passive participant in each session without impacting others.

In some embodiments of the invention which have multiple categories of participants (e.g., active or passive participants), a user interface may comprise a listing of users engaging in a session and may identify users in the listing by their categorization (e.g., as either active or passive participants) through a visual indicator such as an icon or formatting or in any other suitable way.

In some embodiments of the invention which permit users to engage in multiple sessions at once, a user may be able to receive content information (e.g., media data such as song data) for presentation for only one session, such that, if the content is songs, only one session is outputting music through the speakers at a time. In some such embodiments, a source of content information may not send the data for the content to users not being presented with the content to save on network bandwidth, while in other embodiments the content information may be transmitted but discarded when received.

Some exemplary implementations for permitting users to engage in multiple sessions at a time are described herein, but it should be appreciated that these implementations are merely illustrative and embodiments of the invention are not limited to being implemented according to these or any other techniques.

In some embodiments of the invention, a user interface may further permit users to select content to be added to the play schedule, from any suitable source as discussed above. In some such embodiments, the user interface may further provide to the user recommendations or warnings on listed content. For example, in some embodiments a user interface may indicate to a user that a content unit was recently played, or previously played within a time threshold (e.g., played within the last hour), or has been recently played a threshold number of times (e.g., five times within the past day). These recommendations/warnings may provide a benefit to the users in creating a good listening/viewing experience as it allows users to avoid over-presentation of content that may annoy some users. Further, in some embodiments the user interface may warn a user that a particular content unit will not be able to be presented immediately (e.g., may be presented only after a delay) for any of numerous reasons. For example, the source on which the content is hosted may be unable to quickly provide the content to all users in the session, or, if the content is already being transmitted to the users, because one or more users in the session may not have yet buffered locally a sufficient amount of the content information for the content to be available immediately. Determining whether the content will be available for immediate presentation may be done in any suitable manner, such as by examining a reception rate for content, a transmission rate for the content from the source, and/or a presentation rate for the content (e.g., a bit rate) that would tell how fast the content would be presented, and determining an amount of information necessary to have stored locally for a delay not to be experienced during presentation, or may be done in any other suitable manner. Exemplary ways that recommendations/warnings may be determined and presented to users are described herein, but it should be appreciated that these techniques are merely illustrative and that embodiments of the invention may include a user interface that provides any suitable recommendation or warning, and that the determination of those may be made using any suitable techniques.

Embodiments of the invention may also implement any suitable technique or techniques for exchanging content information between a source and a user's computer to be presented to the user. Some illustrative techniques are discussed herein, but it should be appreciated that embodiments of the invention may exchange media data in any suitable manner. In some embodiments of the invention, a source for media data may receive multiple requests for content—e.g., multiple requests for one unit of content and/or multiple requests for multiple units of content—and each request may, in some embodiments of the invention, include an indication of a time the content is needed (e.g., for media content to be presented, an indication of the time it will be presented in the play schedule may be provided). The source may then prioritize responding to the requests in an attempt to distribute content in compliance with the times needed. In some embodiments, the source may prioritize according to the time, and serve content which is needed at an earlier time before content that is needed at a later time, even if the request for the later-needed content arrived after the request for the earlier-needed content. Additionally or alternatively, a prioritization may be determined based on portions of content, such that portions of the same content may be prioritized differently. For example, in some embodiments a beginning portion of later-needed content may be prioritized above an end portion of earlier-needed content. For example, in systems where users may reorder content in a play schedule, it is beneficial to have a local buffer of content data in the event a particular unit of content is reordered to be the currently-presented content. Thus, by pre-buffering some beginning amount of all content, it may be ensured that when the playlist is reordered by selecting a new content unit it may be presented immediately.

Prioritization may also, in some embodiments, be based on availability rather than, or in addition to, time. For example, in some embodiments wherein multiple sources may be available, if a particular unit of content is available from multiple sources then it may be given a lower priority by one of the sources. As another example, in embodiments of the invention where user computers may exchange portions of the content information between themselves, a source may prioritize a first portion of content information which was previously transmitted to one computer below a second portion of the content information which has not been transmitted to any computer. In some embodiments of the invention, a prioritization for a request may be determined by the computer making the request, as an alternative to or in addition to the source. Any suitable technique or techniques for exchanging information may be used, including any of the exemplary techniques discussed herein.

A play schedule may also be edited in response to the exchange of content information. Exemplary techniques useful in illustrative applications for editing a play schedule in response to conditions such as these are described herein, but it should be appreciated that embodiments of the invention are not limited to implementing these techniques and may implement any other suitable technique(s). For example, if one or more computers determines that content which is to be presented may not be available for presentation at the time indicated by the play schedule, then the computer may automatically (i.e., without requiring user selection) reorder the play schedule to move the content to a different time in the play schedule at which it will be available, and/or may move up in the play schedule a content unit which will be available for presentation immediately. The updated play schedule may then be transmitted to the other computers and/or server, which may respond accordingly (e.g., present content according to the updated play schedule). In some embodiments of the invention, other computers may not respond to the updated play schedule request until it is determined that a threshold number of users has a problem in receiving content, while in other embodiments of the invention other computers may respond to the problems of a single computer. This may be done, for example, to prevent a single user with a faulty, insufficient, or busy connection from affecting other users in the session and ensure that the overall session is not affected until a substantial number of users are affected.

It should be appreciated that exchanging content between a plurality of computers may be done in any suitable manner using any suitable medium or media and any suitable protocol. For example, in some embodiments, content may be exchanged between the plurality of computers over a communication network comprising wired and/or wireless communication media, such as an infrastructure or ad-hoc Local Area Network (LAN) or a Wide Area Network (WAN), or any other suitable private or publicly-accessible communication network, including the Internet. Additionally, it should be appreciated that, as used herein, a computer (or computing apparatus/device or client computer) may be any suitable computing device, including a laptop or desktop personal computer, a server, a personal digital assistant (PDA), a mobile phone (including a smart phone) or any other processing device.

Any of the techniques discussed herein may be implemented as any suitable combination of computer-executable instructions implemented on any one or more computer-readable medium, including computer storage media. The computer-executable instructions may be adapted to be executed on any suitable processor, and, in some embodiments, the computer-executable instructions may be retrieved from the computer-readable medium or media and executed on a processor. The processor may then control a computing apparatus in response to the instructions to, for example, present a user interface on a display device coupled to the computing apparatus or present content through a sound and/or video output. In some embodiments, the processor may, in response to the instructions, control the computing apparatus to request and/or retrieve content from local and/or remote content sources, including from other computers accessible over a communication network.

In examples discussed herein, for clarity, content units may be referred to as songs or other audio content and the shared media experience may be described as a shared listening experience. It should be appreciated, however, that embodiments of the invention may operate using any type(s) of content, including any of music, movies, audio books, animation, slideshows, video clips, television programs, etc., and types of content other than media content.

In one exemplary implementation, a shared listening experience may be achieved through a simultaneous listening experience. Simultaneous listening may involve a group of users; a music library; a shared play schedule containing multiple songs that indicates which song from the library to play at what time; a shared time base (clock) that with the play schedule determines what should be playing at the present instant; a means for the users to seethe playlist; a means for the users to collaboratively edit the playlist; and a way to cause changes to the playlist by one user to be promptly reflected in what the other users see and hear.

In implementation, certain additional elements may be employed. There may be an assembly process that looks at the clock, looks at the play schedule, retrieves the right songs from the library, and stitches them together into an audio stream. This assembly process may work a little bit ahead of the current time to avoid buffer underruns, but not work too far ahead of the current time, or it may not be promptly responsive to changes in the playlist. Also, the audio stream may be put through some kind of digital-to-analog converter (DAC), so it can turn into sound, so the user can hear it. This DAC may be driven by a clock, which may run faster or slower than it is specified to, causing it to drift out of synchronization with the shared clock. There may be a means of compensating for this drift, and this means may be either to cut out parts of the audio stream to catch up and insert regions of silence to slow down, or to resample the audio stream based on an estimate of how fast or slow the DAC clock is running relative to its nominal speed.

The functions and advantages of these and other embodiments of the present invention may be better understood in context, and are presented below in various examples and illustrative environments. It should be appreciated, however, that these examples are intended only to facilitate an understanding of various aspects of the invention but do not exemplify the full scope of any aspect of the invention, as the aspects of the invention described herein are not limited to these examples.

### Exemplary Implementations and Environments

For context, described below are various illustrative scenarios and environments in which the techniques described above may be implemented.

### Scenario 1: Centralized Web Service Using Single Server-Generated Stream

In this embodiment, there may be a web server (or several web servers) connected to a database server and a file server containing songs stored as mp3 files. The play schedule may be stored in the database as an ordered list of songs to play, and each entry in the play schedule references a song file on the file server to play. Users may visit a Web page to see the current play schedule. Links or buttons on the page let the user change the play schedule, by changing the order of the entries, removing entries, or adding entries. When adding entries, the user may be prompted to select from a list of the files available on the file server. Or, if the user wants to add a song not on the file server, he may upload a file from his hard disk to the file server. (In this case, the file can be deleted after it plays, or it can remain to be added again later; and if it is able to be added to other play schedules, it can either be available to other users to add, or just the user that uploaded the file; all according to appropriate site policy.)

When one user changes the play schedule, the other users who are looking at the Web page displaying the play schedule are made to see the change. This may be done by polling, in which Javascript is included in the page to periodically contact the server over HTTP to see if there have been changes, and if so update the page. The polling may be, for example, once every three seconds, or any other suitable time. It can also be done by “server push” or other strategies, for example by leaving an HTTP connection to the server open over which updates are periodically received in the form of Javascript commands.

A stream server may also be connected to the database and the file server. It contains a process called a streamer that constructs a single audio stream that is to be broadcast to all of the listeners. That audio stream is then fed into a broadcast daemon. The user's computers connect to the broadcast daemon and the broadcast daemon sends a copy of the stream to each of them. A standard protocol may be used for the broadcasting, such as Shoutcast or RTP. That makes it possible to use existing media player software or web browser plugins on the client side to receive and listen to the stream.

When the streamer starts, it may contact the database and retrieve the current play schedule, then contact the file server and open a song listed on the play schedule, such as the first song. One way to do this is for the streamer to mount the filesystem on the file server using a standard network filesystem protocol like NFS. (If the streamer is running on the same physical computer as the file server so that the file is local to it, then it can open the file directly.) It may then begin streaming out the file to the broadcast daemon. When it finishes streaming the file, it may contact the database to remove the entry that it has just finished playing from the play schedule, and retrieve the next entry in the play schedule. It may then open and begin streaming this new entry, and the process repeats.

When a user uses the Web interface to change the play schedule in a way that results in a change to the currently playing song, it may send a signal to the streamer. If the Web server and the streamer are running on the same physical computer, then it may use a local interprocess communication mechanism—for example, on a Unix host, a Unix signal may be used, such as the Web server sending SIGUSR1 to the streamer. If the Web server and the streamer are running on different computers, then a message bus technology such as JMS should be used.

Upon receipt of this signal, the streamer may perform a query on the database to retrieve the currently playing song. If the song it is playing is not the same as the song that is listening as currently playing in the play program in the database, it could immediately stop streaming whatever it is streaming and begin streaming the song listed in the play program.

When the streamer begins streaming a new file, it may record the time that it began streaming it in the database. When generating the Web page showing the current play program, the web server could read this information from the database and use it to show the current play position in the playing song (e.g., the amount of playback time remaining for that song.)

The Web page showing the play schedule may include client-side Javascript that predicts the time that currently-playing song will finish playing based on the play schedule information sent in the page, and at that time, removes that song from the display and bumps up the next song after it to currently-playing status, and then repeats the process for that song, etc. This way, the client need only receive updates from the Web server or streamer when the play schedule is changed by another user, not when a song finishes playing normally. Depending on the mechanism used to send messages to the client, this allows the polling frequency to be lower than it otherwise might be, or reduces the number of “server push” messages that need to be sent. Over a long time, the client's clock may drift out of synchronization from the streamer's clock, potentially resulting in an incorrect song being displayed as currently playing. But this is not a problem in practice because the play schedule update messages are still frequent enough to keep the display approximately in synchronization. If this is found not to be the case in an implementation, a synchronization message may be generated every few minutes.

The streamer may output audio data to the broadcast daemon as fast as the broadcast daemon will read it, or at any other speed. The broadcast daemon could contain a FIFO buffer. Audio data received from the streamer may be added to the buffer as it's received as long as there's buffer space, and then the daemon should temporarily stop accepting audio data from the streamer until there is once again buffer space, preferably using TCP flow control. Simultaneously, as an ongoing process, the daemon may remove audio data from the buffer and send it to all connected listeners. The rate at which data is removed from the buffer and sent to the listeners should be equal to the rate at which the data is supposed to be consumed by the connected clients, as determined by the codec used to encode the audio. For example, in the case of a variable bitrate mp3 stream using a 44.1 KHz sampling rate, the stream could be scanned to find mp3 frame boundaries, and a frame worth of data may be removed from the buffer and sent to the listeners an average of every 26.1 milliseconds, no matter the size of a particular frame in bytes. However, in maintaining this rate, several frames may be sent at once, so that more than one frame is sent in every TCP packet if that is possible at the encoding bitrate and TCP maximum packet size in use, and TCP header overhead is thus minimized. This real-time-based streaming process may be driven by reading the server's system real-time clock to measure the passage of time.

The size of the FIFO buffer in the daemon could be as small as possible, such as the smallest size that still prevents buffer underrun conditions in regular operation. For example, the size of the FIFO buffer may be 500 milliseconds, and the streamer may in this case output small packets of data, such as the size of a single mp3 frame, to minimize buffer underruns.

In this example the broadcast daemon's local clock provides the time reference that is used to control the advancement of the playlist. But the system can be structured to use a different clock as a reference point. For example, the streamer could pace its output using a clock instead of sending as fast as possible, and then the broadcast daemon would not need to reference a clock. Alternately, the Web servers could synchronize their system clocks with the streamer and/or broadcast daemon using a protocol like NTP, the Network Time Protocol. Then the streamer would not have to write the play start time to the database when a song starts playing, or remove songs from the play schedule in the database when they finish playing. Instead, the play schedule would include the time that each song is scheduled to play, expressed in the synchronized timebase, and the Web servers and streaming system would independently compute what is supposed to be playing at a given point in time by looking at the clock.

### Scenario 2: Client-Side Scripts to Drive a Client-Side Media Player

In this embodiment, as in Scenario 1, there are web servers, a database server containing a play schedule, and a file server containing music. But there may be no streamer or broadcast daemon, nor an audio stream assembled on the server.

The users use their web browsers to visit a web page served by the web servers. The page that may be served up contains a Javascript program that runs in the user's web browser, and the current state of the play schedule is dynamically included in the web page as it's served in such a way that it's readable by the Javascript program. One way to do this is to make the web servers dynamically generate, as a string, and include in the page the code for a Javascript function that returns a Javascript value that represents the current play schedule state. The return value of the generated function may be a Javascript list with one element for each upcoming song in the play schedule, in order of their scheduled play order, and each element could be an associative array containing the properties of the corresponding play schedule item, such as its play start time, play duration, a URL where the media file to play for this time period may be retrieved including any necessary access credentials (username, password, or URL query string parameters), and/or the metadata describing the song that the user should see, including the title, artist, and album name of the song.

The generated page may contain another Javascript function that runs when the page has finished loading. This function may call a playback synchronization function and exit. The playback synchronization function may look at the current time and then examine the play schedule to determine what song should be playing at the moment, the time offset in that song that should be playing, and the URL at which that song file can be retrieved as specified in the play schedule. It may do this by finding the entry in the schedule for which the current time is later than the start time of the entry, but earlier than the start time of the entry plus the play duration of the entry, and then subtracting the scheduled start time of the entry from the current time to obtain the play offset.

The synchronization function may automatically direct the user's computer to begin retrieving that URL and playing the song contained in it starting at the computed offset. It may do this by programmatically creating an instance of a media player plugin that is either built into or shipped with the web browser, or built into or shipped with the user's operating system, and sending that media player first a command to play the resource at the URL, and then a command to seek to the computed play offset. If this is not possible, then the web page can instead embed an instance of a widely distributed virtual machine plugin such as Flash or Java, and load a media player program into this virtual machine that is capable of playing back a song file from a URL at an arbitrary start offset. However, in this case, the Same Origin resource loading security policy of the virtual machine may need to be obeyed, which may mean that either the media file URLs should be hosted in the same domain that served the web page, or the user may be prompted to authorize the virtual machine for extra privileges.

The user may be provided with means to change the play schedule as in Scenario 1, and changes to the play list may result in updates being distributed to the Javascript browser environments of all participating users as in Scenario 1. The updates may be distributed by a poll or push mechanism. When an update is received, the machine-readable representation of the play schedule stored in the client-side Javascript environment may be updated and an invocation of a synchronization function triggered to adjust playback to the correct position in the event of a play schedule change.

The synchronization function may contain additional logic to detect the case where a media player has already been created and playback has already started. In this case, the function could detect the song that the player is currently playing and the offset that is currently playing, and take one or more actions to bring the player back into synchronization with the play schedule. If the incorrect song is playing, then the function may send a “switch URL” command and then a “seek” command to the player, but otherwise no new URL need be sent. In the latter case, the function may go on to compare the correct playback offset to the actual current playback offset and send a “seek” command if they differ substantially, such as by two seconds or more, or by 500 milliseconds or more if system clock synchronization of better than 100 milliseconds can be obtained between server and the client based on network latency and so forth. This minimizes the audible “skips” that users hear when the play offset in changed. Also, if it is almost time for a song transition to occur, such as within 250 milliseconds of the time that the new song is supposed to start, the function should go ahead and send a “switch URL” command to begin playing the new song.

The client's system clock may not be synchronized with the system clocks of the other clients. The clients may be in different times zones, or may simply not have their clocks set correctly. If this were not corrected for, different clients working from the same play schedule would play different music at the same instant in time. To correct for this, when the synchronization function computes the “current time” that is compared to the play schedule to determine the currently playing song and play offset, it may compute it by taking the current system time and adding a correction factor. The correction factor could be an additive offset chosen such that adding it brings the local system time in line with the system clock of the web server that served the page, and then the server clocks may be synchronized using a protocol such as NTP. This correction factor may be computed by Javascript in the served page after the page loads but before calling the synchronization function for the first time, by performing an asynchronous HTTP request to the web server using, ideally, the XMLHttpRequest mechanism. On receiving this request, the server may simply return its current system time. The client Javascript may compute the time T1 that the request was made, the time T2 that the response was received, and note the server time Ts reported in the server's response, and set the correction factor C equal to (Ts+(T2−T1)/2)−T2. Of course, the clients could alternately contact a dedicated time server instead of a web server from the same pool that served them the Javascript code, and long-running clients can periodically re-perform the estimation of C.

Similar to Scenario 1, when the play schedule changes, the display visible to the user may be changed, preferably using the Document Object Model API. In updating the display, the Javascript code may take care to correctly indicate the currently playing song by computing the current time (with the correction factor applied) and comparing it to the play schedule. This update may be performed as part of the synchronization function.

The synchronization function, before finishing, may compute the time that the currently playing song will finish, and create a Javascript timer that will re-invoke the synchronization function around the time that the song will finish. For example, it may set the timer for 100 milliseconds before the song will finish. When the synchronization function then runs at this time, assuming the play schedule has not changed, it could tell the media player to play the new song and update the user-visible display, and the new song could begin playing substantially on time. Clipping of the end of the previous song could be under a fraction of a second and generally tolerated by users, however if it is necessary in a particular application to avoid either the beginning or the end of a song, small windows of silence, such as 500 milliseconds in length, should be inserted in the play schedule between each song to provide time for the transition to occur.

Instead of receiving the initial play schedule state as a dynamic inclusion in the generated code, it could instead be retrieved specially via XMLHTTPRequest, or as part of the usual update polling mechanism, but this approach creates additional latency.

When a user modifies the play schedule, the server may look at the current time and may remove any entries in the play schedule that have completely finished playing. This prevents the size of the play schedule in memory from growing without bound. Performing this trimming when a user modifies the play schedule reduces the need to send updates to the client that do nothing other than flush old entries from the play schedule and thus saves on network traffic. However, in some environments, for example if the clients have particularly unreliable clocks, it may be desirable to generate these flush messages.

For the media player to being playing a song file at an arbitrary offset 0 without first downloading all portions of the file up to 0, it may be provided with a seek table that relates time offsets in the song to byte offsets in the file. The song file may be encoded as an mp3, and the seek table may be encoded as Xing VBR seek tag and placed at the beginning of the song file, and when directed to play at an offset 0 greater than zero, the media player may download just the beginning of the file, including the seek table stored there, and use the seek table to compute the proper offset at which to begin downloading and playing back the file to effect playback starting at 0. Alternately, the seek table can be distributed along with the play schedule and inserted into the media player module by a Javascript call, if that is supported, or the media player can be informed of a separate URL at which the seek table can be loaded when it's needed, or it can be distributed by some other method.

If the file servers containing the music files are too slow, or the network connecting them to the users is too slow, then users may find that the beginning of each song, the first few seconds, do not play, and instead silence is heard, because it may take the file servers a while to receive the request from the media player to begin sending the file and send the initial data to the media player. In this case the upcoming songs could be prebuffered, that is, the program could begin loading them before it is time for them to start playing. The media player used may support a prebuffering command, and be instructed to begin downloading the beginning of the song that is scheduled to play next by the synchronization function when the synchronization function makes a change to the currently playing song. If the media player doesn't support a prebuffering command, then it may be possible to simulate it by using two instances of the media player. One is playing the current song; the other has been instructed to play the next upcoming song, but has been paused or had its output volume sent to zero, such that it begins downloading its assigned URL but does not play it audibly. Only when the time comes to play the next song is the latter player instance made to play the downloaded song audibly.

Some media players have native support for playlists: they can be told in one command to play first the file at URL A, and then the file at URL B, and so forth. If such a player is in use, the synchronization function may function in a somewhat different way: whenever the play schedule changes, it may load the entire playlist into the media player, and then set the appropriate playing entry and offset in the playlist, respecting the time correction factor computed above. This reduces the need for the synchronization function to wake itself up with a timer to change the currently playing song and thus results in smoother, more precise song transitions and prebuffering. However, the synchronization function may still need to use a timer to update the user-visible indicator of the currently playing song in the play schedule. (If the media player can call a externally-defined Javascript hook when the current song changes, that may be used to update the display rather than a timer.) In any case, when updating the currently playing song display, it may be done by querying the media player to determine what song it is in fact playing, rather than by consulting the system time and the play schedule to determine what song it is supposed to be playing, in order to give a greater impression of synchronization to the user.

Moreover, all of the above (in fact everything in this document) can be implemented in environments other than Javascript running inside a web browser. For example, the synchronization could be written as ActionScript running inside an Adobe Flash-derived virtual machine, which would have the potential advantage of tighter integration with the Flash media streaming and prebuffering functions. Or, the client could be written as a downloadable native application, for example a Cocoa application running under Mac OS X, and could communicate with the servers with a proprietary binary protocol rather than HTTP. Nor must communication occur over the Internet; for example, a client for a low-power mobile device might be written in ARM assembly language and communicate with the server over the EVDO wireless data network. Implementations on a wide range of platforms are readily possible.

### Scenario 3: Additional Sources of Media in Centralized Environments

In some embodiments, when using the systems described in Scenarios 1 and 2 above, users will sometimes want to add music to play schedule that is on their computers' hard disks but which is not present on the file server. In this case, the user may be allowed to upload files on his hard drive to the file server. The standard HTTP upload mechanism may be used to send the file to the file server for maximum compatibility, although, alternately, upload can be performed through an embedded Java or Flash application. As the file is uploaded, a record may then be stored in the server database indicating the path to the file on the file server and the identity of the user that uploaded it, and when, in the course of the upload, the metadata for the file is received (typically in the form of an mp3 ID3 tag) that may be recorded in the database as well if present. Then, in the future, when adding a song to the play schedule, the user can view and select from not only the music on the file server that is available to all users, but also the music he has uploaded. It may appear to the user that he has a private “locker” in which he can store his music files.

A privacy flag may be stored with each user in the database. If the flag is set, then the music the user has uploaded can only be viewed and selected by him. If the flag is clear, then the music is also visible to the other users who are listening to the same play schedule as the user who uploaded the music, and these other users can also select from the music and add it to the play schedule. The privacy flag could also be maintained per uploaded song rather than per user, if users request finer-grained control. Also, users may be permitted to store in the database a list of other users (“friends”) that can view the user's uploaded music and select from it and add it to play schedules, even if the user who uploaded the music isn't online at the time, or has selected a different play schedule to listen to.

Uploads of music may be done in a separate browser window that is popped up for the purpose so that the user can continue to interact with the service while the upload is in progress. Users may not be prevented from adding songs to the play schedule even if they have not fully finished uploading to the file server.

Some users have very large music libraries, so large in comparison to the speed of their internet connections that uploading them to the central file server may be infeasible. For these users, a library server daemon may be available. This client daemon may be a native application that the user downloads and leaves running in the background on his computer, and it connects to a library manager daemon (the “server daemon”) that runs in the server data center and is connected to the database server. The client daemon may hold a persistent TCP connection open to the server daemon.

On startup, the client daemon may scan the user's music library on his hard disk, opening each media file and reading its metadata tags. It may assign a unique ID number to each file, and maintain an associative array mapping each ID to the local path to the file that was assigned the ID information such as number. For each sound file found, the client daemon may then send to the server daemon the song's metadata strings (title, artist, and release), total play time, total file size, encoding format and bitrate, and unique ID to the database server. The server daemon may record all of this information in a database table, as well as a second unique ID number indicating the client daemon connection, and this music may be treated just as if it existed in the user's locker on the server (the user may browse it and add it to the play schedule, and may allow selected other users to do the same as described above.)

When such a song is actually added to play schedule through the web interface, one or more steps may be taken to cause the song to get uploaded from the user's computer to the file server so it can be streamed out. The web server handling the addition request may create a new, empty file with a previously unused, unique name in a separate temporary directory on the file server. It may then insert a row in an upload request table on the database server containing the file ID number chosen by the client daemon, the client daemon connection ID number chosen by the server daemon, and path to the new empty file on the file server. It may create a new entry in the play schedule in which it records the path to the new file on the file server. In this entry it may set an additional “temporary upload” flag.

Periodically, for example, twice a second, the server daemon may query the database for rows in the upload request table that have a client daemon connection ID number associated with one of its connected client daemons. For each such row that it finds, it may remove the row from the table and send an upload request message to the client daemon over the TCP connection, indicating the file ID number from the row. In response, the client daemon may look up the ID in its local filename map table, open the corresponding file, and begin uploading it over the TCP connection. As the server daemon receives the file data from the client daemon, it may write it to the file on the file server indicated in the upload request row that it had read. (Instead of polling the database twice a second, a message bus service could instead be used for interprocess communication if available.)

When an item is removed from the play schedule, for example by a web server in response to a user request, if the “temporary upload” flag is set, it also may delete the file in the temporary area on the file server as it is no longer needed. In Scenario 1, this may be done by the streamer when it removes an entry from the play schedule because it's finished playing. In Scenario 2, the server daemon may do a database query every minute to find playlist entries that have finished playing based on the current time that have the “temporary upload” flag set, remove them, and delete the files.

When the client daemon's connection to the server daemon terminates, after allowing the client daemon a 30 second window to automatically reconnect, the server daemon may remove all of the song metadata uploaded by the client daemon from the database, since the files may no longer be available after the disconnection. (However, to improve client daemon startup speed, the files could merely be marked as unavailable in the database. Then the next time the client daemon connects, only the differences between the information held over on the server and the list of files available on the client could be sent, using a synchronization process such as the rsync algorithm. Once the server database has been synchronized with the files actually available on the client, the files are marked as available again.) Also, the server daemon may perform a database query to find all play programs that include files that were being uploaded by the client daemon, but which were not fully uploaded, and issue database updates to remove these entries from their play programs. These removals may be handled just like removals issued by the user through the Web interface in that an update message may be sent to the other listeners and, if a streamer is in use, it may be sent a signal too.

The client daemon may monitor the user's media library for the addition, or deletion, or change of media files after the initial connection, and send metadata add, delete, or update messages to the server in response, to keep the server's image of the available files up to date. If available on the user's platform, an asynchronous filesystem monitoring API may be used, for example the FSEvents API on Mac OS X. Otherwise the local filesystem may be polled (periodically rescanned), such as every 15 minutes.

Since in some implementations songs can be added to the play program before their corresponding files on the file server are fully uploaded, when sending the play program state to the users' computers, the web server may include the percentage each file in the play program that has actually been uploaded when sending the play program to the clients, and send updates to these percentages every minute. It could do this by looking up the eventual, correct size of the file in the database, and then looking at the size of the actual file on the file server, for example using the stat( ) Unix system call. This may help users order the play program to give the transfers sufficient time to complete.

In Scenario 1, before beginning to stream a file, the streamer may check to make sure that it has been completely uploaded (as above, using stat( ).) If not, the streamer may reorder the play schedule to move the first fully uploaded file to the currently playing song position and begin playing that instead. If there is no entry in the play schedule whose file is fully uploaded, then instead of beginning to play a new song, the streamer may send five seconds of silence and then check the file sizes again, continuing this process until a song is fully uploaded. Alternately, the streamer could estimate transfer rates and begin playing a song if it is projected to upload rapidly enough that it will finish transferring before the streamer encounters end-of-file, but this may have the disadvantage that if the transfer rate decreases after the song has started to play, then the streamer might not be able to complete sending the file.

In Scenario 2, when clients attempting to retrieve a file receive an end-of-file, short read, or seek-past-end-of-file response because the file is not fully uploaded, they may wait five seconds and retry the request. It is also possible to periodically run a task using a server daemon that performs database queries to detects cases where not fully transferred songs are about to become the currently playing song and reorders the playlist to avoid that as described above.

### Scenario 4: Full Smart Client Implementation

By moving more intelligence to the client, it's possible to build a system that maintains tighter playback synchronization (e.g., playback time differences between clients of tens of milliseconds or even less.) Moreover, clients can transfer media data directly between themselves in some cases without going through a central server, decreasing the operating costs and increasing the scalability of the service.

### Generally

There may a central server running a program called Mothership, and a set of clients. The clients may run a desktop GUI application and connect to Mothership over TCP. The clients and the Mothership may exchange serialized binary messages over the connection. Some exchanges are remote procedure calls (for example, the client sends a request message, like “add song,” along with a request ID number, and the Mothership attempts to perform the action and sends back a response message with a status code and the same request ID number, enabling the client to match the response to the request.) Some are asynchronous notifications (for example, the Mothership sends the client news of an update to the play schedule as a result of another user's action.)

There is optionally one or more computers running a program called Relay. Relay can run next to Mothership in the server datacenter, or it can run in the background on user machines, or its functionality can be built into the client as a subprogram, etc.

In addition to connecting to the Mothership, the clients occasionally connect to each other. Also, connections are occasionally made between the clients and the Relay, if used.

As will be described, a server like Mothership is not necessary, and a fully peer-to-peer setup, using no such centralized servers, is also possible.

### Synchronizing Clocks

All participating processes (Mothership, Relay, clients) may run on computers that have local system clocks that measure the current time of day. These clocks may not be very accurate, either in how they are set or the rate at which they advance.

There may be a time server that speaks NTP (the standard Network Time Protocol). Mothership, Relay, and the clients use NTP, the time server, and the passage of time as measure by their local system clocks to estimate the current time in US Atomic Time. A function can be called to read the current estimate at any time, and this time will be referred to as “Global Time.” The current time as measured by the (possibly inaccurate) local clock will be referred to as “Local Time.”

Some NTP client implementations may attempt to prevent outputting time estimates that appear to decrease (to prevent time going backwards) or otherwise smooth out their output (to prevent time jumping forward abruptly to correct for accumulated error.) In some applications, this is not necessary, because the system is designed to understand Global Time as only a best estimate that can change. Instead, when asked for Global Time, the NTP client implementation may produce the best estimate it is capable of at that moment, without reference to previous estimates it's produced.

NTP queries may be made to keep each process's Global Time estimate may be synchronized to within 100 ms (milliseconds) of truth, or, better, within 10 ms if sufficient time server capacity is available, or any other suitable threshold.

In the fully peer-to-peer case, NTP can be performed amongst the participating clients rather than in reference to a central server.

### Representing Time

A global timestamp (a precise moment in Global Time) may be represented as a nonzero number of microseconds since 00:00:00 UTC, Jan. 1, 1970 (known as the Unix epoch.) This number may be stored as a 64-bit unsigned integer, and in this format is here known as a timestamp_t. The “_t” is a naming convention indicating a type.

A time difference or a duration may be represented as a number of microseconds (positive, negative, or zero), and may be stored as a 64-bit signed integer, and that format is here known as a duration_t.

Microsecond precision may be used because it may be enough to accurately specify the exact time instant that a particular sample in a digital recording should play at sampling rates of up to 1000 KHz. In practice, the most common sampling rate is 44.1 KHz, and sampling rates above 96 KHz are rarely used. So, this may be sufficient precision for referring to a particular sample in an audio stream, but is independent of the sampling rate used.

### Constructing Seek_Data Blocks

A seek_data block is a data structure that contains the information about the layout of a mp3 compressed audio file. A seek_data structure may be queried with a duration_t t_in to determine a pair t_out, offset such that t_out<=t_in, t_out is situated an mp3 frame boundary, and offset is the byte offset in the mp3 file at which begins the mp3 frame where mp3 decoding should begin to get audio data starting at offset t_out in the encoded song. The largest possible t_out<=t_in may be returned given the information contained in the seek_data.

To construct a seek_data block may require the actual mp3 file, which may be scanned to build a table with the start offset of every frame. Since mp3 frames are only 1152 samples long, this table may be large. To reduce the amount of storage space necessary, in generating seek_data, the table may be compressed or decimated.

seek_data is stored in one of two formats. If there are integer constants first_offset and fixed_size such that the offset of frame i is exactly first_offset+fixed_size * i for all i, then the file is said to be regular and seek_data consists simply of the constants first_offset and fixed_size.

If that's not the case, the file is said to be irregular, and the actual frame offset table may be decimated and stored as the seek_data. A small integer frame_interval may be chosen, such as 38, and one out of every frame_interval byte offsets are stored in the seek_data. The seek_data may contain the offset of the first frame (frame 0), the offset of frame frame_interval, the offset of frame 2*frame_interval, and so on, and additionally the byte offset of the end of the last frame in the file. The value for frame_interval chosen may also be stored in the seek_data.

In practice, many mp3 files are nearly regular in that the location of frame i can be described by the formula offset(i)=first_offset+fixed_size*i+k(i), where first_offset and fixed_size are constants and −16<=k(i)<=16 for all i. In this case, a regular seek_data can be written, with a flag set to indicate that it will be necessary to examine a small (e.g., 32 byte) window around the predicted point for an mp3 frame header to find the exact frame starting location. (Other values can be used here besides −16, 16, and 32.)

### Representing the Play Schedule

The play schedule may be represented by a timestamp_t startTime and an ordered list of entries. Each entry may contain any or all of a unique entry ID, the title, artist, and album name of the song to play, the seek_data for the song, the amount of time the song is to play as a duration_t playTime, the identity of the user that added the song, the identity of the user from whose music library the song was selected, and a globally unique identifier (GUID) that can be used to begin retrieving the actual mp3 data to play. The GUID may be an opaque string, a URL, the number of a database entry, or the hash of the mp3 file to retrieve, and may contain any extra authentication credentials (usernames and passwords, session cookies, certificates) which may be necessary to retrieve the resource.

The entries are to play in order they are given in the list. The timestamp_t may identify the time that the first entry should begin playing. Adding the duration_t of the first entry to the timestamp_t gives the time that the second entry should begin playing, and so on. Since these time measurements may be accurate to a microsecond, this allows a sample-accurate specification of the stream to assemble and play.

One, some or all of the following operations (mutators) may be defined on a play schedule. Let entries[i] represent the ith entry in the list, indexed from 0.
trim(nominalTime). While there is at least one entry and starttime+entries[0].playTime<=nominalTime, add entries[0].playTime to startTime and remove the first entry. If this causes the entry list to become empty, instead set startTime to 0. The result of this is to remove all entries that finish playing before nominalTime from the list without changing the meaning of the list
add(nominalTime, beforeId, ordered list of entries). First perform trim(nominalTime). If it has not been done already, set the id field of each entry to a value that does not already appear as the entry id of some other element currently in the list. Then, if there is entry in the list with id equal to beforeId, insert the provided new entries immediately before that entry. Otherwise, insert them at the end of the list. If the result of this is to change the entry that would be playing at nominalTime (the first entry after performing the trim), set startTime equal to nominalTime in order that the new entry begins playing at the beginning.
move(nominalTime, firstId, count, beforeId). First perform trim(nominalTime). If there is no entry with id firstId in the entry list, stop. Otherwise, remove count entries starting with firstId from the list, and hold them in reserve. (Count is a small nonnegative integer.) If there are not count entries following firstId, then just take however many there are. Then, take these selected entries, and reinsert them before the entry remaining in the (that is, not part of the selected entries) with id beforeId. If there is no such entry, instead reinsert them at the end of the list. Finally, if the entry specified to play at nominalTime has changed as a result of this, set startTime equal to nominalTime.
remove(nominalTime, firstId, count). First perform trim(nominalTime). If there is no entry with id firstId in the entry list, stop. Otherwise, remove count entries from the list starting with that with id firstId. If there are not enough, just remove however many there are. Finally, if the list has become empty, set startTime to 0, otherwise, if the entry specified to play at nominalTime has changed as a result of this, set starttime to nominalTime.

This representation offers general advantages in some applications: It is unique, in the limited sense that if two nodes compute the same play schedule and hash it, each will get the same hash code, which makes it possible to, for example, digitally sign the play schedule. (In particular, starttime is always well-defined.) It is “time invariant” or “unclocked” in the sense that it does not need to be updated when a song finishes playing, and in fact trim( ) need never be performed explicitly. It provides a clear way to account for possible clock desynchronization by dealing with nominalTime explicitly as a mutation parameter instead, for example, referencing local system time. The mutators are completely defined (there is no combination of current state and mutation parameters that is left undefined) and cannot return errors or raise exceptions. It provides robust handling of race conditions, in that if two or more users pick mutation operations at the same time, not being aware of each other's intentions, they can be performed in any order and still give results that are likely consistent with the users' intentions. (This is a result of using a durable, unique ID to indicate each entry rather than an offset, as well as careful definitions of parameters and exceptional behavior with an awareness of likely user intention.)

Maintaining/Synchronizing the Play Schedule using Mothership

The Mothership may maintain the authoritative copy of every play schedule. When a client wants to begin tracking a play schedule, it may send a subscription message to the Mothership, indicating the play schedule that it wants to track. On receipt of this message, the Mothership may take a lock (mutex) on that play schedule, send the current state of the play schedule to the requesting client (its starttime and complete entry list), add the client to a list of subscribers to changes of that play schedule, and release the lock.

When a user wants to change the play schedule, his client may perform a remote procedure call (RPC) over the TCP connection to the Mothership, indicating the play schedule to change, the operation to perform (add, remove, or move), and any necessary parameters (beforeId, firstId, count, but not nominalTime, and in the case of an add, entry data, but possibly not the unique entry ids for the entry, which can be assigned by Mothership to avoid race conditions.) The Mothership may determine if the user is authorized to make the change, and if not, may deny the request. The user's client may need not to be subscribed to updates to the play schedule.

Otherwise, the Mothership may take a lock (mutex) on the play schedule, compute nominalTime as its current estimate of Global Time plus a bias factor and perform the mutation operation as described above. It may then send the type of mutation operation (add, remove, or move), along with the parameters of the operation (this time including nominalTime, and if necessary the entry IDs assigned to newly added entries), in a message to all clients on the update subscription list for the play schedule. It may then release the lock. The bias factor may be zero. However, if it takes the clients time to react to a change in the playing song and begin playing a new song, for example if the network link between the Mothership and the clients is high-latency, or in some of the peer-to-peer cases below, it may be a positive value such as 500 ms or 2 seconds. If this is done, then changes to the currently playing song may be scheduled to happen in the future, so every client has the opportunity to receive and react to the change in advance, and all of the clients are able to begin playing the song at the same time, at the beginning. The bias factor may be adjusted dynamically based on, say, observed network conditions.

On receiving the notification of an update, each subscribed client may perform the same mutation operation, in the order received, to reconstruct the new state of the play schedule.

Alternate: Play Schedule Maintenance without a Central Server

The Mothership may act to (1) put the requests from clients in an authoritative order, and thus resolve races between clients (such as: if two clients try to add an entry to the end of the queue, which entry goes at the end and which entry goes second to last?), and (2) establish the authoritative time (nominalTime) at which each operation is said to occur, and thus resolve races against GlobalTime (such as: was an entry moved immediately before, or immediately after, a particular entry finished playing, as these two interpretations may result in different final states)

A Mothership may be used to resolve these races. However, it's also possible to build a fully peer-to-peer version of the entire system, if it is not possible to supply a central server like Mothership. In this case, when joining the system, clients may retrieve the initial play schedule state from a peer, and mutations may be flood-filled out to all peers interested in a particular play schedule. nominalTimes may be assigned to the mutations by the clients initiating them, and each mutation may be given a unique ID. As a client receives mutation messages, it may perform them in order of nominalTime, using a mutation's unique ID as a tiebreaker if the nominalTimes are the same. Each client may maintain a history list of recent mutations, and the starting state before the first operation in the history list was performed, so that if a mutation arrives that has a (nominalTime, unique ID) sort key that is earlier in time than the last operation performed because it arrived out of order, the mutations may be re-performed with the newly arrived mutation in its correct place. An entry may remain in the history list for an amount of time equal to the maximum flood-fill time for a message across the peer-to-peer mesh, and when a new client connects and retrieves the initial play schedule state from a peer, it may receive this history list as well.

In a hybrid case, a Mothership (or other distinguished node, such as an elected peer) may be used to resolve races, but the update notifications are distributed to a large audience using a peer-to-peer relay tree or mesh in which a peer may receive an update notification and passes it on to other peers close to it. However, since there may be many clients watching a play schedule, it may be desirable to not require each client to connect to the distinguished node, yet suppose the peers are untrusted.

In this scenario, there may be a public/private key pair associated with each play schedule. The Mothership may order the mutation requests and assigns nominalTime as usual, and after performing the mutation, it may serialize and hash the new play schedule state (the startTime and the entire entry list), and cryptographically sign the hash of the play schedule with its private key. The mutation message broadcast across the peer-to-peer mesh may include the operation type (add/move/remove), the operation parameters (including nominalTime and newly assigned entry IDs), and the signature of the new play schedule state. On receiving an update message from an untrusted peer, a client may make a complete copy of the last known play schedule state and may apply the mutation operation. It may then serialize and hash the new state of this modified copy, and test the signature included in the update message against the hash. If the signature is incorrect, it may reject the update and discard the modified copy. Otherwise, it may accept the change and replace its stored state with that of the modified copy. It may also save the signature provided.

In this approach, a new client, joining a session, may get the object state (the play schedule in this case) from a peer, rather than having to connect to the central server, and the peer may tender the signature that it saved from the last update as proof that the object state is true and correct, or was at some point in time.

The peer may then send a list of update messages as it receives them, and because the initial state and update messages are sent over a reliable connection, there is no worry about missing or duplicating a message, etc, as there would be if the new client had to connect to the authoritative server to get the initial state and separately subscribe to an update stream from a peer.

### Client Cache

When a client wants to listen to the stream described by a play schedule, it may retrieve the play schedule and keep it up to date, as described above. The client may begin retrieving the media (actual mp3 data) associated with each entry in the play schedule, using the media GUID in the entry.

How and when that may be done is described below, including, for example, ahead of time; unless it is certain that there is no shortage of network bandwidth, and will not be in the future, the client may not wait until a song begins to play to begin retrieving it.

Instead, a client may have a local temporary storage area (a “cache”.) Preferably, the cache is a database, for example in SQLite format. The client may start a retrieval thread that looks at the play schedule and begin retrieving the media resources referenced by it using their media GUIDs and storing them in the cache. Likewise, when the thread sees that a media GUID no longer appears in the play schedule, it may mark the corresponding media data in the database as unused. The data marked unused may be deleted, to minimize the risk of the user attempting to extract the media data from the cache and make a permanent record of the song that played, which may not be permitted by copyright law. However, if this is not a concern, then unused data may only be deleted when disk space is scarce, and on a least-recently-used (LRU) basis. This makes it possible to save bandwidth if a song is played several times (perhaps in several different play schedules) before it is evicted from the cache.

The cache may be encrypted on disk to prevent users from unlawfully extracting media data from it for which they do not have a license. In one embodiment, each cache may be assigned a unique cache ID number, which may be stored in the database. For each cache, a symmetric cipher key may be generated and stored in persistent storage in the Mothership, and a table in the Mothership may relate the cache ID to the cipher key. On startup, the client may read the cache ID and send it to the Mothership. The Mothership, in cooperation with the client, may conduct a series of tests to validate that the client is an official, authorized client and has not been modified, that a debugger may not be attached to the client, etc. As part of this process, the Mothership may negotiate a shared secret with the client, using pre-distributed cryptographic public key certificates to ensure that a third party cannot intercept the secret. On successful completion of these tests, the Mothership may send the cache key to the client, encrypted using the shared secret to protect it from eavesdroppers on the network. The client may decrypt the cache key, obscure it, and store it in memory (for example by XORing with a variable value, dividing it into several parts, and storing the parts in noncontiguous memory locations.) The memory may be flagged as ineligible to be swapped out to disk using, for example, the POSIX mlock( ) call. Now, when data is written to the cache, it may first be encrypted with the cache key, preferably using a symmetric cipher thought to be secure such as AES; when data is read out of the cache, it may be decrypted with the cache key before use.

### Playback Synchronization

Now the client has an up-to-date play schedule and a cache that may be presumed to contain the media corresponding to the play schedule. It may also have seek_data for the entries in the play schedule, which has been distributed with the play schedule as noted above. And it may know the current Global Time.

To generate an analog output signal that the user can hear, the user may have a Digital-to-Analog Converter (DAC) in the form of his sound output hardware. The DAC system may be modeled as a FIFO buffer, a clock, and a latch (a one-sample memory.) The clock ticks at the DAC's configured output sample rate, for example 44.1 KHz when playing a sound file sampled at that common rate. Every time the DAC clock ticks, it removes a sample from the end of the buffer and writes it to the latch. On a continuous basis, the DAC may generate an analog output level determined by the current value in the latch, so every time the DAC clock ticks, it may change its output based on the next sample read from the FIFO buffer.

The DAC clock is usually entirely separate from the host computer's system time, so there are now three separate concepts of time in play in each client: Local Time, Global Time, and the actual rate at which the DAC clock is ticking. Typically DAC clocks are not very accurate, and a DAC clock that has been configured to tick at 44.1 Khz may tick faster or slower by 1% or more, and the DAC's clock actual tick rate may change with time, as, for example, the physical temperature of the computer changes.

The operating system running on the client's computer may provide a driver that allows application programs such as the client to send audio data to the DAC. Though these interfaces vary in their specifics, a typical one, such as Apple's Core Audio, can be modeled from the application's perspective as follows: The application may select a desired sample playback rate, such as 44.1 KHz, and designate a function in the application to serve as a callback. When the DAC's buffer is nearly empty, the operating system may generate a call to the callback, passing a pointer to a buffer and a number of samples. The application may write the specified number of samples to the buffer and return. The operating system may add these samples to the front of the DAC buffer. The DAC gradually drains the buffer, and when it is nearly empty, the application may receive another callback.

In making the callback, the operating system may also pass a timestamp, indicating the actual time (in Local Time) that the first sample written by the application in response to the callback will be latched by the DAC and will play. If the operating system doesn't provide this, it may be estimated by a variety of means depending on what the operating system does provide, for example by querying the operating system for the total size of the intermediate buffers that actually exist between the application and the DAC, or by asking the user to perform a calibration procedure ahead of time in which he is to hit a key when he hears a tone play, or in the worst case by estimating the play time to be equal to Local Time when the callback is made. In general, the same mechanism that the operating system provides to synchronize playback between audio content and video content can be used, since the same problem is being solved. However computed, the application should subtract the current Local Time from the estimated play time to get an estimate of the latency through the audio output subsystem, and store this estimation.

The client may create a novel data structure called a CouplingBuffer. A CouplingBuffer is a specialized kind of FIFO that contains audio samples and tracks underflows, and can be modeled as a standard FIFO of audio samples plus an underrun counter U which has an initial value of 0. Data may be written to a CouplingBuffer; just like other FIFOs, this causes the data to be added to the front of the FIFO (assuming U=0 for the moment.) Data may be read from a CouplingBuffer; just like other FIFOs, this causes data to be removed from the end of the FIFO and returned. However, suppose R samples are read from the CouplingBuffer, but only A are actually available in the FIFO at the time, with R>A. In this case, the A samples are returned, followed by an additional R−A samples of silence (these samples should be zero-valued), and the quantity R−A is added to U. When U>0 and W samples are written to the CouplingBuffer, then if U>=W, the data is discarded without changing the FIFO and W is subtracted from U. On the other hand, if U<W, then the first W bytes of the data are discarded, the remaining W−U bytes are written to the FIFO normally, and U is set to zero. In other words, the CouplingBuffer is an audio sample FIFO that can “go into debt.” Underflows may be handled by returning silence, and then when the audio data whose late arrival created the underflow does finally arrive, it may be discarded so as to not distort the timebase of the audio stream. The CouplingBuffer should be implemented as a ring buffer of a fixed size, preferably 131072 samples, plus an integer counter to track U, and should be threadsafe for at least one reader and one writer. An entirely analogous CouplingBuffer can be constructed for video frames instead of audio samples by returning blank frames instead of silent samples.

When the application receives a callback from the operating system to fill the DAC buffer, it may read the requested number of samples from the CouplingBuffer, which, because of its special underflow behavior, is guaranteed to be able to provide them. Underflows typically result when the computer has an insufficiently fast CPU to handle transient load (such as another application starting up) and the high priority DAC callback may run but the application may be unable to get sufficient clock cycles to respond by filling the buffer.

The application may have a thread called the audio commit thread whose purpose is to write to the CouplingBuffer. The behavior of the thread may be controlled by two constants, a high threshold, preferably 1 second, and a low threshold, typically 500 ms. When the playtime of the audio in the CouplingBuffer becomes less than the low threshold, the commit thread may attempt to compute audio samples to play, and send them to the CouplingBuffer until the accumulated of audio in the CouplingBuffer is at least equal to the high threshold, or until it runs out of samples to send. Then it may stop working until the length of the CouplingBuffer once again falls below the low threshold, which it may detect by periodically polling the CouplingBuffer, such as once every 100 ms.

An audio source may be an instance of an object called Mp3 Stream that represents an instance of an mp3 decoder. To construct an Mp3 Stream, three pieces of information may be used: the time offset (as a duration_t) in the mp3 at which playback should start, the media GUID that can be used to retrieve the mp3 data from the cache, and the seek_data for the mp3 as described above.

An Mp3 Stream object may support one primary operation, read(count), which returns the next count decoded samples from the mp3. If the samples aren't available for any reason, for example because the necessary data is not present in the cache, read( ) may return exactly count samples, with silence (zero-valued) samples at the points where the request can't be fulfilled. Mp3 Stream may handle all possible error recovery internally.

Internally, Mp3 Stream may contain a decode time offset and a read time offset (both duration_t) as well as the usual mp3 decoder state. When Mp3 Stream is initialized, it may set the read time offset to the desired starting point for decoding. It then may use the seek_data to set the decode time offset by determining a pair (decode_time_ofset, byte_offset) such that starting mp3 decoding at the frame beginning at byte_offset will yield samples from the mp3 stream starting at decode_time_ofset and decode_time_offset corresponds to an mp3 frame at least 10 frames earlier in the mp3 than the frame containing the read time offset, but in any event no earlier than the beginning of the first frame, where additionally decode_time_offset is the latest time offset that can be found using the available seek_data that satisfies these criteria. Mp3 Stream then may initialize the mp3 decoder state, locate the mp3 data in the cache using the supplied media GUID, and begin reading data for that GUID from the cache for that file starting at byte_offset and feeding it into the mp3 decoder. (The reason that decoding may begin at least 10 frames before the desired position is that some mp3 decoders, when beginning to decode in the middle of a stream, require several frames to synchronize their internal state with that of the stream, and before that point they may output glitchy audio. 9 frames are thought to be generally required, and an additional frame is preferably added as a safety measure.)

When read(count) is called on an Mp3Stream, if the decode time offset is not equal to the read time offset, then compressed data may be fed into the mp3 decoder from the cache, the output of the decoder may be read and discarded, and the decode time offset may be advanced accordingly (based on the length of the audio discarded), until the decode time offset is equal to the read time offset. If the cache runs out of data, the read is said to fail temporarily. Otherwise, compressed data then may be fed into the mp3 decoder from the cache, the output of the decoder may be copied out of Mp3Stream to the caller, and both the decode time offset and the read time offset is advanced, until count samples have been read. If the cache runs out of data as this is happening, the read is again said to fail temporarily. If the read fails temporarily in any case, silence samples may be copied out of the Mp3Stream to the caller until count samples have been written as requested, and the read time offset (and only the read time offset) is advanced to reflect the silence samples written. The failure is only temporary because the needed data will hopefully arrive in the cache soon and decoding can continue. However, if this causes the difference between the read time offset and the decode time offset to be greater than a resynchronization threshold, which may be 522.4 ms, then the Mp3Stream should be reinitialized from the beginning, preserving only the read time offset (in other words, the seek_data may be consulted to find a new decode time offset that is closer to the read time offset, effectively skipping over a part of the file that was not in the cache and could not be loaded in time.) However, before doing this, seek_data may be consulted, and the reinitialization may not be performed if it would cause the decode time offset to assume a value less than its current value.

For reads beyond the last frame in the mp3, Mp3Stream may return silence samples.

The Mp3Stream samples that Mp3Stream outputs may be at a fixed sample rate, such as a 44.1 KHz sample rate, though 48 KHz may be used if a higher quality is needed at the expense of efficiency. If other mp3 sample rates are supported, the Mp3Stream may resample them to the fixed samplerate internally. This makes it possible to switch between playing mp3 s of different sample rates without telling the operating system to reset the DAC's clock rate, which may involve closing and reopening the sound device and a corresponding loss of synchronization, though this strategy may also be appropriate. Alternately, the resampling may take place in AudioOutput, for example as part of the DAC drift compensation option described later.

Now, with Mp3Stream defined, we may continue defining the behavior of the commit thread. The commit thread may be represented by an object called AudioOutput. Generally, an AudioOutput simply has an associated Mp3Stream, which can be changed from time to time by a method on the AudioOutput, and when it is time to fill the CouplingBuffer and n samples are required to fill it to its high threshold, the AudioOutput may read n samples out of the Mp3Stream and copies them to the CouplingBuffer. However, it's also possible to set a trigger on the AudioOutput. A trigger may be defined by a Mp3Stream read time offset and a function to call when that offset is reached. AudioOutput may contain a loop that does the follows: If a trigger point is defined and the current read offset of the Mp3Stream is equal to the trigger point, then call the trigger function and clear the trigger point. Then, compute n, the number of samples required to fill the CouplingBuffer to its high threshold, and compute t, the number of samples that must be read from the Mp3Stream to advance its read offset to the next trigger point if one is defined, or an infinitely large value otherwise. If n is zero, exit the loop and begin waiting for the CouplingBuffer's length to fall below the low threshold. Otherwise, compute x as the minimum of n and t and read x samples from the Mp3Stream and copy them into the CouplingBuffer.

The AudioOutput may have a method to get the Mp3Stream's current read offset, and a method to get the estimated time that the next sample read from the Mp3Stream (at the read offset) may actually be latched and converted to an analog voltage by the DAC. The latter may be computed by adding the total play length of the current contents of the CouplingBuffer to the estimated operating system audio output latency as described above. The latter quantity is called the estimated buffer duration.

Now we turn to the method by which the play schedule and the current time may be examined to generate commands for the CouplingBuffer. This may be handled by another object, an AudioSynchronizer. The AudioSynchronizer may have a function called syncAudio( ). This function may first determine the current Commit Time, which is the time that the next sample copied out of an Mp3 Stream by the AudioOutput will actually play, though more exact means can be used if supported by the operating system, and which may be computed by adding the estimated buffer duration (as retrieved from the AudioOutput) to the current Global Time. Then, it may look up in this Commit Time in the play schedule to determine the media GUID GUID_ideal of the song that should be playing at that time, and subtracts the play start time of that song from the Commit Time Time to get the offset O_ideal in that song that should be playing then. It may then determine the song GUID_actual that is actually set up to play then. If the AudioSynchronizer has just been created, then nothing is set up to play, otherwise the song that is set up to play is the GUID that the AudioSynchronizer last used to create an Mp3Stream, which it may remember. Next, it may determine O_actual, the offset that is actually set up to play, which may be the read time offset of the Mp3Stream.

Then, if the GUID_ideal is different from GUID_actual, the AudioOutput may be synchronized to play GUID_actual starting the O_ideal, except that if O_ideal is less than ENTRY_START_SNAP_TOLERANCE, preferably 100 ms, then offset zero may instead of O_ideal. Otherwise, if GUID_ideal=GUID_actual, then the absolute value may be computed from O_ideal−O_actual. If it is greater than DRIFT_TOLERANCE (e.g., three seconds), then the AudioOutput may be synchronized to play GUID_actual starting the O_ideal. In any case, to synchronize the AudioOutput may mean creating an Mp3Stream for the selected media GUID at the selected offset and setting it as the AudioOutput's current stream.

Regardless of whether synchronization occurred, the remaining current entry play time may be computed, which may be defined as the positive difference between Commit Time and the time at which the currently playing song should finish playing as defined in the play schedule. An AudioOutput trigger may be set to call syncAudio() again in the minimum of the remaining current entry play time and MAXIMUM_POLL_TIME, such as one second.

The effect of this policy is that AudioSynchronizer may check every MAXIMUM_POLL_TIME to see if the actual playback position has drifted more than DRIFT_TOLERANCE from the correct play position, and if so, may seek playback back to the correct play position. This may not happen except on songs longer than five minutes or DACs more than 1% away from true. Rather, regardless of the amount of accumulated drift, the next song may begin playing at the correct Global Time, regardless of whether the DAC has finished consuming the previous song. If syncAudio( ) arrives late to start the playback of the next song at the chosen Global Time, up to ENTRY_START_SNAP_TOLERANCE of initial desynchronization may be tolerated to prevent clipping off the beginning of the new song. Speaking of the larger system, if the media does not appear in the cache fast enough to feed playback, then the user may occasionally hear bursts of silence, but if then the media does resume appearing in the cache, then playback may resume at the correct, synchronized point in time, by decoding and discarding a few samples of the discontinuity is short, or by skipping over the unavailable part using seek_data in the case of longer discontinuities. And if not enough CPU resources are available to keep up with decoding, then again, the user may hear silence, and playback may then resume at the correct point when they're caught up.

Note that in this model, media playback may be driven by the DAC clock, but may be synchronized to an estimate of Global Time.

The above policy may be implemented, for example in a mass-market application that shares a computer with other unknown applications and should minimize its CPU usage. However a technique may be implemented that substantially increases synchronization (to within 10-50 ms rather than to within DRIFT_TOLERANCE as in the above approach.) That is to estimate the actual rate of sample consumption by the DAC with respect to Global Time. Whenever syncAudio( ) runs (typically every MAXIMUM_POLL_TIME, or 1 second), it may compute the actual elapsed Global Time e since the last time that it ran, and note the total duration of samples d that have been written to the CouplingBuffer by the AudioOutput since the last time it ran (by inspecting the Mp3Stream read time offset.) It may then update an estimate r of the actual current speed of the DAC's clock using a simple filter, by performing r=a*(d/e)+(1−a)*r, where a is an update rate constant, such as 0.01, and r may be initialized originally by averaging together d/e samples from the first 60 executions of syncAudio( ), until which the prior update equation is not performed and r is considered to be 1.0. r may be greater than 1.0 when the DAC clock is running faster than it should, and less than 1.0 when the DAC clock is running slower than it should. AudioOutput may be extended with a method setSampleRateModifier, and each new computed value of r may be passed into the AudioOutput by syncAudio( ) by calling this method. AudioOutput may be further modified to resample the audio data that passes through in, in between the read from the Mp3Stream and the write to the CouplingBuffer, based on the ratio r, preferably using a sinc-derived bandlimited interpolator. If the DAC speed clock is relatively stable, even if that speed is not correct, this may result in much tighter synchronization, particularly on long tracks, because the principal source of drift is reduced or eliminated.

When the currently playing song changes as a result of a play schedule change (for example, the currently playing song is removed by a user), it's possible to change to the new song faster than in the above implementation. The CouplingBuffer may be destroyed and then recreated and refilled, so as to not wait for the samples in the CouplingBuffer to play before the new song begins. In an even more extreme implementation, the sound device may be closed and reopened using the operating system sound API to flush any other intermediate buffers that may exist between the application and the DAC. However, this is typically not necessary for a satisfactory experience.

### Libraries and Adding Music

When the client starts, it may scan a list of directories configured by the user for music files, assign the files unique identifiers, extract metadata from the files, build a map of unique identifiers to filenames, and send the metadata and unique identifier to the Mothership as described in Scenario 3 (the client assume the role of the client daemon and the server may assume the role of the server daemon.) When user presses a button to add music to the play program, a window may appear offering the user a choice of songs to play, selected from all of the other users who are able to select to listen to the play schedule to which the user is proposing to add the music. This window may be an HTML display, and it may display a Web page served by Mothership using HTTP made from user library data that the Mothership has stored in a SQL database as described in Scenario 3, though there's no reason for the user to know that. However, this song selection window could also be made of native GUI widget. In that case, the client may synchronize the library lists of the other eligible users down from the server with an algorithm like rsync or by sending a database change long.

When the user selects a song to play, Mothership may send a message over the persistent TCP connection to the user in whose library the song resides, including the unique ID the client chose for the song, along with a addition request ID, which is an integer. The client may compute opens the indicated file, compute seek_data, copy the file into its cache (or, preferably, inserts a reference to the file in its cache), construct a GUID that references the file and its current availability from the client, and send a message back to Mothership answering the request, including the addition request ID, the title, artist, and album name, the seek_data, the play duration of the file as a duration_t (as measured when building the seek_data), and the constructed GUID. The Mothership may then perform an add operation on the appropriate play schedule (based on the add request ID) and sends notice of the add operation to all subscribers. The client may continue to make the file available from its cache until it receives a “request invalidate” message from the Mothership with the request ID, which the Mothership may send when it detects that the song has finished playing or has been removed from the play schedule to which it was added. To support this, the Mothership should store, for each play schedule entry, the request ID associated with the entry if any, and an indicator of which client connection the request invalidate message should be sent on.

User may also add files from the hard disk without adding them to their library and advertising them to the server. In that case, the user may compute seek_data and extract metadata, copy or link the file to the cache, construct a GUID, etc, and directly initiate an add mutation request on the play schedule. In this case, the user's client may subscribe for updates to the queue schedule so that it can directly detect when the file has been removed or has finished playing.

### Transferring Media: Generally

One remaining question is, how does the actual mp3 data get from the cache of the user who has the song to the caches of the users who are listening to it?

In one implementation, each client may open direct peer-to-peer connection to the clients of the other users who are listening to the same play schedule as it. Additionally, it may open connections to all of the clients out of whose libraries songs have been added to the play schedule to which the client is listening, considering upcoming and currently playing songs only, not songs that have finished. It may open connections to all of the clients in either category, but if that's not possible, it may open connections to a subset, for example a random subset of 10 connections.

Additionally, if Relays are in use, there may be zero or more Relays associated with play schedule, and all clients listening to the play schedule or adding music into the play schedule from their libraries connect to the Relay as well.

Each connection may be bidirectional and the protocol may be symmetric. Each connected pair of clients may perform an ongoing negotiation in which the clients identify parts of files that one client has in its cache that the other client would like to receive (presumably because that part of the file is mentioned in the play schedule that the client is listening to).

Having identified a part of a file that could usefully be sent from a client A to a client B that is connected to it, A may negotiate a commitment to send the part to B, which may cause B to decline commitments from other clients that might also wish to send it the data. A may then send the agreed data to B.

If A has more requests from B and other clients than it does uplink bandwidth to the Internet, a typical case, then it may evaluate the relative priority of each request and preferentially fills the higher-priority requests. Included in the priority calculation may be the Global Time that B is projected to need the data (as reported by B or independently determined by A from the Mothership), and the number of clients other than B that could fill the same request, both relative to other requests that A could fill.

Relays may perform the same general functions as clients but may have different priority rules, so in the above, “client” should be taken to mean “Relay or client.” The word “node” will be used below to encompass both.

### Mechanics of P2P (Peer-to-Peer) Connections

Opening a connection between two arbitrary computers on the Internet, even if they are both willing and have a side channel through which they can negotiate the details of the connection, is in the general case impossible and in the common case difficult. This is primarily because of the presence of Network Address Translation (NAT) devices on the Internet. Users who are connected to the Internet only though a NAT do not have a proper IPv4 address and thus cannot receive incoming connections in the usual way, since they have no address to which a connection can be initiated. If one user is behind a NAT and the other is not, then the user behind the NAT can connect to the non-NAT user. But if both users are behind NATs, then a more complex strategy can be used. Note that most or many home Internet users, with cable modems or DSL lines for example, are behind a NAT. Here we present a powerful way to open a connection between two users that may work even if both of them are behind NATs. Like a normal TCP connection, the connection is sequenced, reliable, and stream-oriented, in the senses that these terms are used in the TCP literature.

The general strategy is to establish bidirectional UDP communications through the NATs with the initial help of Mothership, and then create a TCP session and tunnel it over the UDP link.

First, the node may establish an endpoint for communication by creating a UDP socket and binding it to a random or arbitrary local (source) port number. It may save this port number for future use (the “local source port number.”) This endpoint will be referred to below as the node's socket.

Each node may then go on to attempt to determine the list of (IP address, port) pairs that other nodes can use send data to this socket—the node's “name list.” First, it may perform an operating system call to enumerate its network interfaces and notes those that are configured with a specific Internet address, excluding the loopback address 127.0.0.1, broadcast or multicast addresses, and other addresses known to be special. Each resulting address may be an address at which the node could potentially be reached by some set of peers, so it is added to the name list with a port number equal to the local source port number. It might be a global (publicly routable) address, in which case any client can reach it at that address, or it might be a private address, perhaps in a reserved IP address range (for example the address 192.168.0.2), at which only one or two computers in the same physical location (for example, behind the same NAT) may be able to reach it.

Second, to finish the list, it may attempt to discover the address from which packets it may send to hosts on the Internet appear to originate. It then send a UDP packet from this socket to an address discovery server, for example using the STUN protocol. This server may reply with a second UDP packet giving the apparent source address and port of the packet in the body of the packet. This address and port is added to the node's name list. If it is the same as an address already in the list, the node may not be behind a NAT, and that address is a public address which can be connected to from all over the world. Otherwise, the node may be behind a NAT, the IP address is that of the NAT's, and the NAT has just created a temporary port mapping that routes packets received on that IP address and port to the node at its socket. What may be unknown is whether the NAT is willing to respect this mapping and route packets in this way for every host on the Internet, or just the address discovery server.

The node may register the completed name list with the Mothership. Just as the Mothership may allow a client to subscribe to updates to play schedule state, it may also allow nodes to subscribe to updates to the set of node name lists associated with a play schedule (associated because, for example, the node is listening to the play schedule, is the source of music that has been added to the play schedule, or is a Relay associated with the play schedule.) The new name list may be set to all registered subscribers to the play list. Periodically the node may check for changes to its name list by re-performing the detection process (walking the interface list and doing a STUN query.) If it finds that its name list has changed, it may send the changed name list to the Mothership, which may result in another change message being sent to the other subscribers.

When a node registers its name list for the first time, it may also receive a unique node ID number, which may also be included when its name list is sent out to the other subscribers.

The node may determine the set of other nodes to which it should initiate connections by subscribing to name list updates for the play schedule to which it is listening (upon subscription, it may receive the initial list, and then it may receive updates as the set changes as described above.) If a Relay, it may also subscribe to name list updates for all of the play schedules for which it is serving as a Relay. If a node is merely adding a file to a play schedule, it may not initiate connections, as other nodes will initiate connection.

The node may then initiate connections using these name lists. (Set aside what these “connections” actually are for a moment.) To initiate a connection, the node may simultaneously begin connecting to some or all of the (address, port) pairs listed in the remote node's name list. At the same time, it may send a connection request message to the Mothership, passing the node ID of the other node. When the Mothership receives this message, it sends a connection initiate message to the other node using the other node's Mothership connection, passing the first node's name list. The other node may respond to this by simultaneously beginning connections to the first node on all of the first node's known (address, port) pairs. So the result of this is that at one node's initiation, both nodes are attempting to the connect to the other node using all of its possible names. (The LAN-local names like 192.168.0.2 still have to be tried, because connections to the NAT's external public address may fail from behind rather than outside the NAT, so LAN-local names may be the only way for two nodes on the same LAN behind a NAT to connect to each other.) Some of the connections will fail, but some, hopefully, will succeed. More than one might succeed. Once connected, each node may send its node ID to the other node, and all but the first connection between a pair of nodes may be closed. As the list of nodes associated with a play schedule changes, nodes respond by initiating or dropping connections, striving to keep one connection open to each relevant node. Since the protocol is symmetric, it may not matter which node opened the connection, and only one is needed.

So, what is the nature of these “connections”? Each node may contain a full implementation of TCP, and the protocol that is spoken is simply standard TCP, except that instead of being sent directly over IP, each TCP packet is sent over UDP, using the UDP sockets established earlier. The TCP implementation can be complied into the application program that's distributed and run entirely in userspace, with no kernel drivers or VPN operations necessary. So to “connect” may comprise telling the TCP layer to begin a new connection according to the TCP protocol, which may result in the full TCP handshaking process, starting with a TCP SYN packet being sent over UDP, with appropriate retransmission if it is not acknowledged.

The reason that the connection procedure above works is that, having made the initial STUN request, many consumer NATs may allocate a port mapping that can then be used to receive packet from other hosts, except that packets received on that port may be dropped by the NAT unless the local host has already sent a packet to that particular remote host, as a clue that the local host is willing to receive packets from the remote host on that port. Because both nodes are made to connect to the other in this implementation, using the Mothership as an intermediary to arrange this, they are both generating traffic to each other, causing each of their NATs, hopefully, to accept the other's traffic on the originally established mapping. This, together with the normal TCP SYN retransmission, may be enough for a connection to go through in at least one direction in many circumstances.

Having established a connection, it may be desirable to send data across it frequently, such as every 30 seconds, in order to discourage the NAT from dropping the port mapping due to inactivity. This can be done, for example, by sending empty “keepalive” messages.

If the TCP stack is implemented in userspace by the application, rather than in the operating system kernel, then it may use different policies or algorithms that may be particularly appropriate for the application. For example, the Vegas congestion control algorithm can be used to reduce the amount of network latency induced when performing uploads across cable modems with limited uplink and large buffers.

In a fully peer-to-peer system with no Mothership, name lists for the nodes participating in a play schedule may be discovered by client advertisement mechanisms, for example though a distributed hash table or though flood fill across a peer-to-peer mesh.

### P2P Negotiation Mechanics

The transfer negotiation may be conducted in any suitable manner, including:

Each node may advertise the GUIDs that it is trying to download, and the byte ranges that it needs in each GUID. It can do this by sending this list to each of its connected peers, for example every 5 seconds. Compression and differencing may be used to reduce the size of the list.

Each node may then review the advertisements received from all of its peers and select a batch of requests that it is willing to fulfill. It may locally mark these requests as tentatively scheduled to be sent, and send to each peer included in the batch an offer message, indicating the requests that it is willing to fulfill for the peer.

On receiving offer messages, a peer may determine if it has already accepted an offer for the same data from another peer. If so, it may answer the offer message with an offer reject message. Otherwise, it may send an offer accept message, and locally mark those byte ranges as scheduled to be received (causing it to reject future offer messages from the same bytes.) However, if the data is not received within a timeout interval, such as one minute, then an accept cancel message is sent to the peer that made the offer, and the byte range is locally marked as needed rather than scheduled to be received.

On receiving an offer accept message, a peer may change the marking on the referenced request byte ranges from “tentatively scheduled to be sent” to “scheduled to be sent”, and add them to a sending queue. The peer is continuously processing the sending queue, removing the next request from the queue, waiting until network bandwidth and buffer space is available, sending the requested data, and repeating. On receiving data, a node may mark it as received and write it to its cache, for playback though a play schedule or possibly for serving up to another node that needs the same data.

On receiving an offer reject or accept cancel message, a peer may remove the “tentatively schedule” or “scheduled” marking on the referenced request byte ranges. This may also be done, silently, if neither an offer accept nor an offer reject is received within a timeout interval after the offer message is sent, such as five seconds.

When the total amount of data in the “tentatively scheduled to be sent” and “scheduled to be sent” is less than a threshold, such as the estimated amount of data the peer can send in the next five seconds based on its estimate of its current sending rate, the node may once again review its peers' current advertisements and send out another batch of offer messages.

An advantage of this three-way handshake (advertise need, offer, accept) is that it allows both the sender and the receiver to modify their behavior in a complex way based on other transfers that are in progress. For example, the sender can ensure that it may only send one copy of a given part of a file, while the receiver can ensure that it only receives one copy of a given part of a file.

### P2P Media Transfer Policy

The next question is, of all of the advertised peer needs that a node can fill from its cache, which should it choose? That is, what offers should it send? How should priorities be assigned to offers in order to compare them?

This decision may be made by balancing two factors. First, it may be desirable to send data that is needed soon earlier. Second, it may be desirable to send data that is available from few or no other sources (that is, resides in the cache of few other peers), both to make the best use of this node's limited upload bandwidth if it has data that no other node has, and to increase the likelihood that the receiving node will have data that it can send on to yet a third node, making good use of the receiving node's upload bandwidth.

The first factor (the play time) may be estimated by having each node inspect the play schedule (which in many cases it will already have a copy of), or, alternatively, in advertising its needs, to include information about the scheduled play time and play schedule position (in the latter case, the Relay may not have a copy of the play schedule, but it may estimate the priority information by taking the highest priority expressed by any of its connected peers and using that as its own priority.) In either case, times expressed in units of timestamp_t or duration_t may then be converted to units of bytes, and this is done by using the seek_data to look up the part of the file that corresponds to a given time range.

The second factor (the other sources) may be estimated by determining the number of other nodes that need a part of a file (by looking at the received advertisements), and comparing it to the number of nodes that have that part of the file (either this data can be added to the advertisements in addition to the needs, or less accurately but often sufficiently, each node can simply keep a count of the number of times it's sent a given part of a file.)

This priority hierarchy may be useful in some, but not all, applications:

In some cases, if this node has the only copy of the data in question, then the request may take priority over any other request where at least one other peer has a copy of the data. Alternately, if it is not possible to count the number of copies of the data available among peers, then use an alternate rule: if the node has not sent a copy of this data in the last 60 seconds, then the request may take precedence over any other request where the node has sent a copy of the data in the last 60 seconds, except that this second form of the rule may be made to take effect only when not sending to a Relay.

Moreover, if it is possible to detect other instances of the client that are on the same subnet as the node, the node may not send any data for which there are other sources not on the subnet if there are any nodes on the subnet that do have data for which they are the only source not on the subnet. (This can be accomplished, for example, by sending a periodic broadcast UDP packet on the subnet, for example every 5 seconds, while this is the case, or by having Mothership detect hosts that are likely to be on the same subnet by comparing their name lists for similar external addresses but different internal addresses and direct them to connect, and then including a flag in their advertisements to each other specifying whether they have data for which there is not another source.) This may prevent one client on a subnet from wasting upload bandwidth that another client on the subnet could put to better use. Properly speaking, “subnet” here and elsewhere in the document should be taken to mean a set of computers whose connection to the public Internet all go though a single choke point of limited bandwidth, such as a cable modem or DSL line.

Those general rules aside, other rules may be implemented according to the application, for example:

First prefer to fill requests where the peer is a relay, and the data is scheduled to play within the next 15 seconds.

Then prefer to fill requests where the peer is not a relay, there are no relays connected, and the data is scheduled to play in the next 15 seconds. (Do not fill requests where there is a relay, and the data is scheduled to play within 15 seconds, but this node is not the relay.)

(If it can be detected that there is a relay peer that has the block, and this node is not a relay, then do not fill the request.)

Then, prefer to fill requests where the data is scheduled to play within the next 15 seconds, preferring earlier play times to later play times, and disregarding the number of potential other sources for the data.

Then, fill requests where the data could become scheduled to play within the next 30 seconds. Specifically, fill requests for data within 30 second from the beginning of any item of the play schedule. Do not fill a request for data later in an item before a request for data earlier in an item, but subject to that rule, fill requests for data that is available from few sources before requests for data that is available from more sources (or, if availability data isn't available, filling requests for data that is needed by more peers first.) Break ties based on the time that the data is currently scheduled to play.

Then, prefer last to fill requests for the remainder of the currently playing item, primarily preferring data available from fewer sources to data available from more sources (or, as above, data needed by more peers to data needed by fewer peers.) Consider the time that the data is scheduled to play only to break ties between pieces of data that are equally scare.

The time constants in this scheme, such as the 30 second point that forms the division between the part of a song that is given special priority and the part that is not, may be made to vary. For example, this priority region can be shortened when network conditions are good or latency is low, and lengthened when bandwidth is scarce or latency is high, and it can vary on a per-track basis depending on the conditions that pertain to an individual song, for example the conditions on the network from which it is being originally sent.

As a further enhancement, when sending its advertised requests, each node may include in the advertisement, for each part of each file that is interested in receiving, the number of copies that the node could make of that file part, computed by counting the number of the node's peers that have also advertised a request for that file part (referred to below as the work value of the file part to the node.) The node may also advertise the total amount of data it would be able to send to its peers if it filled all of its requests, computed by adding together the number of bytes that each of the node's peers have requested that the node has in its cache (referred to below as the node's work potential.)

Then, in making the priority decisions, nodes may favor particular peers over others, sending to nodes with lower work potentials preferentially. This may commonly result in a node sending more data to its faster peers and less to its slower peers, and also may commonly result in peers using all of their upload bandwidth a greater percentage of the time, both of which increase overall network efficiency.

Work potential can be taken into account by setting a work threshold, for example of 100 kilobytes, and identifying nodes below that work threshold as in danger of underrun. Then, in the two situations above in which it is written that ties are broken based on the estimated play time, ties may be broken by first sending to a peer that is in danger of underrun over sending to a peer that is not, and second, within groups of peers that are all in danger or all not in danger, making the transfer that would have the highest work value to the node receiving it, and third, if the receiver work values are the same, sending blocks with earlier play times. Also, in situations other than those two, to break ties, the final criteria can also be the danger status of the receiving peer followed by the work value of the transfer.

### Relay Election

Nodes may be made to detect whether they would be suitable relays by checking for a number of local criteria. For example, a node may consider itself a suitable relay if it has observed sustained uplink speeds above 500 kilobits per second, if its CPU utilization is below 10%, and if the last activity at the keyboard or mouse was at least 30 minutes ago (or other suitable values). Nodes that find themselves to be suitable relays register themselves by sending a packet to the Mothership, and may then unregister themselves from the Mothership later if they find themselves to no longer be good relay candidates.

Clients may detect when they are not receiving media fast enough to satisfy the play schedule and this is due to a lack of aggregate upload bandwidth between the listeners to distribute the media to all listeners, rather than a lack up upload bandwith on the computer from which the media is being originally streamed, and in this case can request the Mothership to assign a relay to the play schedule. For example, a client may detect this condition by observing that it is not receiving fast enough to satisfy the play schedule, yet the media is available from multiple sources that are not on the same subnet based on P2P advertisements messages, and in response may send a request relay message to the Mothership.

In response to such a message, the Mothership may pick an idle relay from the list of registered relays, and assign it to the play schedule, sending a message to the relay informing it of this. The relay and the other listeners can then discover each other's name lists as described above, and the relay can then begin assisting with the transfer of the media between the listeners by receiving one copy of a part of a file and then sending out more than one copy.

A relay can detect when it's no longer needed in a play schedule, for example by observing that it has not sent any data to listeners in the play schedule in a certain amount of time, for example five minutes. It can respond to this condition by sending a de-election message to the Mothership, which can then de-assign the relay from the play schedule (notifying the listeners), and return the relay to the unused relay pool for a future assignment.

It is particularly desirable for relays to have publicly routable (non-NATed) IP addresses, because in that case they may also be used to rescue partitioned listener sets, that is, listeners who cannot connect to each other even indirectly because of NAT traversal failures. These NATs can be specially flagged in the relay list and only assigned if a partitioned listener set is detected. A partitioned listener set can be detected by having each node periodically sending its list of connections to the Mothership, for example, 15 seconds, after joining a new play schedule and then every five minutes, and testing the listener connection graph for unreachable subsets, for example by checking for a path between each pair of nodes. In response to detecting a partitioned listener set, the Mothership can automatically assign a relay with a publicly routable address to the listener set.

### Waiting for Songs to Finish Transferring

If the uplink of the host from which the music is originally being uploaded is too slow, then the song may not be able to play immediately, at least not without skipping. It may be desirable to detect this condition and visually flag songs that are not ready to play without skipping. Trivially, a file that's finished transferring to all users is ready to play without skipping, but we can do better by using the estimated rate of transfer to mark songs as ready to play if they will finish transferring before they finish playing.

The computation may be performed on the client from whose library the song was added to the play schedule (the “serving client”). It can determine if the song is ready to play without skipping based on its own ability to upload the remainder of the file, assuming that the other listeners and relays can distribute the song arbitrarily fast. If so, it may be said to be ready; otherwise it may be said to be held. The Mothership can maintain this hold flag on a per-play-schedule-entry basis and distribute it with the play schedule to all clients watching the play schedule. The flag may be initially set to held; the serving client may change it at any time by sending a hold update request message to the Mothership, passing the addition request ID (see above) and the new value of the flag. The change may then be distributed to the various clients watching the play schedule.

To determine the value of the flag, the serving client may first determine the parts of the file that have already been uploaded, by examining peer advertisements to find parts of the file that are available from other peers not on the serving client's subnet, or by remembering which parts of the file it has sent at least once to peers not on its subnet (the latter estimate can be incorrect if a block is sent to a peer, but that peer then logs out before sending the block to another client.) Subtracting that size from the total length of the file gives the approximate amount of data left to send. The client may then estimate the current rate, in bytes per second, at which it is currently transferring parts of that file. Based on that rate, and the amount sent so far, it can estimate the time that it will finish transferring the file. It can compare that to the time that the song is scheduled to finish playing, minus a safety margin of for example 20%, to determine if the song should be held. This calculation can be performed periodically, for example every 10 seconds, to detect changes to the correct held status of a song.

The Mothership can detect the case where a held song is about to become the currently playing song in a play schedule in the near future, say in the next 10 seconds, and respond by finding the first non-held song in the play schedule, if any, and moving it immediately before the held song. This will reduce the chances that users hear audio dropouts. Also, the client can visually indicate held songs in the play schedule, for example by rendering them in grey instead of black.

### Pausing Playback for Buffering

If a client detects that a song transition has just occurred in the play schedule, but it does not have a comfortable amount of the song loaded such that it can play without skipping, for example the first 10 seconds, and the held flag is clear, then it may be the case that there is sufficient serving client bandwidth, but the song was recently added or abruptly moved up to the currently playing song position, and a few seconds are necessary to give the transfer system time to adapt, recruit a relay if necessary, etc.

In this case, the client may send a pause request message to Mothership. Mothership can tally the number of pause request messages received, and if it is at or above a threshold, for example one if only one user is listening to the play schedule, else the greater of 25% and two, and this threshold was reached near the beginning of the playback of the track, say within the first five seconds, then the Mothership may conclude that the attempted playback of the song should be aborted, some buffering time allowed, and then playback reattempted. It may accomplish this by modifying the play schedule by performing trim( ) to remove all entries before the currently playing one, and then setting startTime to the current Global Time (specifically, nominalTime) plus a buffering interval, for example five seconds, and sending an appropriate update message to all clients subscribed to play schedule updates.

### Other Notes

When adding songs, if the client needs to pick a GUID, it may simply pick a large random number, for example a random 64-bit number.

Users may be give the ability to “seek” or “scrub” the play schedule within the currently playing track, for example, to move the current play position forward ten seconds into the future by, for example by dragging a play position indicator. To do this, a new play schedule mutation operation may be defined that performs trimo and then adds or subtracts a value for starttime, and appropriate request and update messages defined. Likewise, users may be given the ability to pause a play schedule's playback indefinitely, and resume it at a later time. This too may be a matter of new play schedule mutators and request and update messages, specifically a pause mutator that performs trimo, sets a pause flag on the play schedule, and sets startTime to the saved play offset (that is, nominalTime minus startTime), and a resume mutator that clears the pause flag and sets starttime=starttime+nominalTime. The definitions of the other mutators can then also be modified such that they perform no operation, not even trimo, if the pause flag is set, and finally the client, specifically syncAudio( ), can be modified to output no audio for a play schedule if its pause flag is set.

In the examples above, the seek_data is distributed along with the play schedule. This is not necessary. Instead, the listeners can retrieve the seek_data at their own initiative, for example when they begin retrieving the media data. This will save bandwidth because clients who are not listening but still want to know the play schedule will not then have to receive seek_data. The seek_data can be stored on the Mothership when the song is added to the play schedule and then sent from the Mothership to the listeners, either automatically or in response to a client request. Also, the listeners can request it directly from each other (and ultimately from the serving client), in which case the seek_data need not go through a central server at all.

### Scenario 5: Automatically Playing Songs

The Mothership may periodically scan through all play schedules, such as every second, looking for play schedules that have listening users, but less that a certain total amount of music scheduled to play, such as 30 seconds. On finding such a room, it may examine the set of music that users have made available from their libraries for playing in the room, and select a song or album from it, such as randomly. It should then initiate an addition of that selection to the end of the play schedule, such as by sending an addition request message to the appropriate client, and so on, as described above.

### Scenario 6: Listener Presence and Chat Integration

Play schedules may be associated with a chat room where users can talk about the music currently playing, discuss what should play next, or socialize in other ways. Users who would be eligible to listen to a play schedule may also have the ability to see messages sent to the chat room, send their own chat messages, add themselves to the list of users currently present in the chat room, set informational flags about their current participation level (such as whether they are currently listening to the room's associated play schedule whether they are presently at their computer, and whether they are currently typing a chat message that hasn't been sent yet), and view the list of other users present in the chat room and their informational flags. The Mothership may require that clients add themselves to the list of users in the chat room before they can begin listening to the play schedule.

The client may display the chat room and the list of user present side-by-side with its display of the current play schedule.

When a client want to put up a window showing the play schedule and possibly allow the user of listening to it, it may send a join chat message to the Mothership indicating the play schedule, along with its initial participation level flags (also called its presence information.) The Mothership may check the client's access rights to the chat room and play schedule, and if they are insufficient, send a deny error in return. Otherwise, the Mothership may take a lock (mutex) on the chat room, add the user and his participation flags to its list of current chat room users, send a update message to all other existing users indicating that a new user has been added, and send an initial state message to the joining room containing the full list of users currently on the list as well as a selection of recent messages entered by users in chat, such as the last 500 messages. Then Mothership may release the lock. When a user wants to send a chat message, his client may send it to the Mothership, which may rebroadcast it to the other users and also add it to a recent chat history list that Mothership may maintain in order to be able to send chat in the initial state message mentioned earlier. When a user's participation flags change, for example when his client detects that he is no longer at his keyboard based on keyboard and mouse inactivity, his client may send a participation flags update to the Mothership, which may update the participation flags stored for the user in the user list and sends notice of the change out to the other users. When a client leaves the room, either by sending a leave chat message to the Mothership or by losing its TCP connection to the Mothership, it may be removed from the current user list and a notice is sent to the remaining users. As the other connected clients receive the various update messages, they may update their GUI displays in realtime so their users can always see the current state.

An extension may be made to the above, which is the ability to relate chat events to play-schedule-related events that happened at the same time. When a user enters a chat message, and Mothership receives it, and Mothership sees that the song that is currently playing may not be the same as the song that was playing when the last chat message was received, before processing the user's chat message, it may create a pseudo-chat-message containing information about the currently playing song, such as its title, artist, and album strings, and the identity of the user who added it, and a flag indicating that it is a song transition pseudo-chat-message. It may distribute this pseudo-chat-message to all clients in the room user list and adds it to the chat history to be sent to newly connected clients, just as would a normal chat message. Then it may process the user's chat message. On receiving the pseudo-chat-message, a client may render a banner in the chat display indicating a song transition, so that the chat messages that users enter while a particular song is playing appear under a banner indicating the song that was playing, so that if a user says, for example, “I like this song,” then future users reviewing the chat history will understand which song was meant.

Likewise, other types of pseudo-chat-messages, distributed and logged identically but rendered differently by clients, can be generated in other circumstances. For example, when a user adds songs to a play schedule, removes songs, or reorders songs, pseudo-chat-messages with information on these events can be generated and inserted in the chat history, so that future users reviewing the chat history will have an understanding for the events that might have inspired a particular discussion.

### Scenario 7: Multiple Sessions

Human beings have a natural desire to watch other human beings, and users of this system may desire to simultaneously monitor multiple chat rooms and the state of multiple play schedules. However, they may only wish to actually listen to one play schedule at a time.

Users may be provided an interface similar to the tabs available in some Web browser software, where a user can open as many tabs as desired, each showing the current state of a user-selected play schedule and its corresponding chat room. The user can then switch between the various tabs to view all of the activity on the system that he is interested in. To select a play schedule to listen to, the user could double-click on a particular tab. This may cause his client to carry out the procedure for listening to a play schedule as described above. If the user was already listening to a different play schedule, that listening session may cease, so the user is only listening to one play schedule at once. A “speaker” icon is rendered on the tab associated with the play schedule to which the user is currently listening if any.

When a user may switch the room to which he is listening, his participation status flags on his open chat rooms may be updated to indicate to other users the room in which he is listening. The other clients, in turn, as they render their lists of the users currently present in each chat room, visually distinguish the users that are actually listening to the music from the users that are only watching the chat. This may provide a valuable social cue that users can use when selecting music to play.

When a chat message arrives for a room, and the room is not currently visible on the user's screen, for example because a different tab is currently selected by the user for display, then the client may locally set a “new chat messages” flag on the room. The tabs for rooms that have this flag set may be visually distinguished, for example by rendering the text on the tab in bold. When the user next displays the chat room, the flag is cleared. This may make it easy for users to tell at a glance which rooms have unread chat messages.

When a song added by the user is playing in a play schedule associated with a tab, that tab can be visually distinguished, for example by rendering an additional icon on the tab such as a music note. This reminds users when songs that they want to hear are playing, or reminds them to participate in chat if they want to have a conversation with their friends about the song.

Hovering the mouse over a tab that the user is not listening to may mute the current sound output and instead play for the user a preview of the music presently playing in that room. If the music is already in the local cache, it can be played immediately. Otherwise a remote procedure call can be made to one of the users listening in the room to get a short sample of the music playing. It may not be necessary to maintain tight synchronization to Global Time in playing this sample, since it is only a preview, so the peer answering the request can simply send a short sample, such as 5 seconds, of audio that has recently played there.

Users may be allowed to simultaneously remove songs from one play schedule, and add them to another, by selecting the songs in one play schedule and visually dragging them and dropping them onto the tab representing the target play schedule. For example, users may use this feature as they negotiate how a group of friends that was listening together will split up into separate groups as their listening desires change over the course of the day.

### Scenario 8: Aids to Song Selection

The Mothership may keep a log of every song played in a database, for example by recording the song's title, artist, and album, the play schedule in which it was played, the day and time that it played, the users that heard the song play, and if available an acoustic identifier computed using an audio fingerprinting algorithm and the hash of the music file, computed for example by passing the entire contents of the file, possibly by excluding any embedded metadata tags, though the SHA1 hash function.

Then, when a user is selecting a song to add to a play schedule, in rendering the list of song options as the user is browsing them, Mothership can perform database queries to summarize the history relating to a song, computing, for example, how many times this song has been played in this play schedule in total, the day and time that it was last played in this play schedule, the total number of times that the users actually listening to this play schedule at present have heard the song (regardless of the play schedule in which they heard it play), the last time one of these users heard it play (in any play schedule), and so on. This makes some users who otherwise would be reluctant to play a song more socially confident in their choices, thus leading to more songs being added to play schedules and more user activity overall.

To determine if a song in the play history is the same as the song being contemplated, the artist, title, and album strings may be checked for an exact match, the file hash code if present may be checked for an exact match, the acoustic identifiers, if available, may be checked for an exact or an approximate match depending on the fingerprinting technology used, or the artist, title, and album strings may be compared for an approximate match, for example by removing stopwords such as “the” and removing spaces, converting entirely to lowercase, and computing the edit distance between the strings and comparing it to a threshold.

Likewise, the system may indicate where a song, if added to a play schedule, would be ready to play promptly, such as within 10 second, or if it would need to prebuffer for a longer time in order to play successfully, and if so for how long. This may be determined by having the Mothership query the client hosting the file for an estimated buffering time. The client may estimate this by comparing its current average upload rate to peers not on its subnet, determining the number of other files currently added to play schedules from this machine that have not been fully transferred (that is, for which peers who need part of the file exist), dividing the first number by the second to get an approximate bandwidth allocation per file, and determining the approximate play rate of the file by dividing its total size in bytes by its total play duration. If the upload rate is greater than the play rate, then the client estimate that no prebuffering is needed. Otherwise, it may determine at what smaller file size, but equal play time, the play rate would be equal to the upload rate, and subtract that smaller file size from the true file size to determine the approximate amount of prebuffering, in bytes, to perform before the file plays. Finally, it may divide the prebuffering amount by the upload rate to give an estimated prebuffering time. This number is approximate because a transfer could finish, increasing the available upload rate and thus decreasing the prebuffer time, or a new transfer could start, doing the opposite. If it is desirable to offer firmer guarantees on prebuffer time, then adding a song to a playlist may be made to create a bandwidth reservation on the client serving the file, the client may be made to preferentially serve requests for that file until the bandwith reservation is reached in any given timeslice, and the prebuffering time estimation rules may be modified to take this firmer estimate of actual uplink availability into account. However, the prebuffer time may not be completely firm, because it's possible for the actual bandwidth available on the network to change, for example because of network traffic generate by another computer on the network.

Scenario 9: Playing from URLs

Users may be allowed to add media hosted on the Internet to the play schedule directly by typing or pasting a URL into their client. The URL may then be stored directly as the media GUID. On seeing a URL as a GUID for an entry in a play schedule that is being listened to, a client may simply retrieve the media file using the standard protocol specified in the URL (for example http) and store it in the local media cache. However, the client adding the entry to the play schedule may be responsible for determining the play time of the URL (by loading the URL resource, or part of it, to compute its play time; by determining it by an out-of-band mechanism, such as parsing a related HTML page; by prompting the user; or another mechanism), and computing the seek_data if necessary. Alternately, Mothership could be made to handle these task automatically on determining that a particular entry requested for addition has a GUID that is an URL.

This functionality is particularly useful for adding video files to the play schedule, which are often relatively high bitrate files that are already hosted publicly on the Internet. When playing a video file, a client may open a video display window, but otherwise can proceed just as in the audio case. An external video decoder can be used; for example, in implementing playback of flv (Flash Video) files, a video player may be developed in Flash that is passed play time information and URL or filename for the video file, which then handles all synchronization inside the Flash virtual machine using the ActionScript language.

### EXAMPLES

The first and second exemplary embodiments described below may be implemented together. The first describes an embodiment of simultaneous listening where the assembly function is performed on a central server. The server gets the audio files from the library, stitches them together into a stream, and sends the stream to several relatively dumb clients which play it. The second describes an embodiment of simultaneous listening where the assembly function is performed independently on each client. The client looks at the playlist, retrieves the needed media files itself, and plays them at the right time by looking at the shared clock.

The third and fourth exemplary embodiments describe other features that may each be implemented together with or separate from other embodiments described herein. The third embodiment describes the concept of library sharing, where each user has a personal music library, and a user A can play a song out of a user B's personal library for still a third user C. It focuses on the promotional and legal advantages of this arrangement.

The fourth embodiment describes the means by which the music may get from the music library where it is stored to the place where the stream is being assembled (whether it's happening in one place, on the server, as in the first embodiment, or on each client as in the second embodiment). When the library and the assembler aren't connected by a fast network, it's necessary for the assembler to look ahead in the playlist and begin retrieving songs before they are needed to compensate for the slow transfer rate. If the audio data still doesn't arrive in time, then the playlist could be automatically adjusted (for all users) to play something else first to give the transfer more time to complete.

The fifth through eighth embodiments describe exemplary user interface features and ways that may be used to structure a list of upcoming songs or other media. These embodiments of the invention may each be implemented together with or separate from other embodiments of the invention.

Examples below are given in terms of music and songs, but it should be appreciated that in other embodiments of the invention may be implemented to work additionally or alternatively with any form of audiovisual content: e.g. video, slideshows, etc.

Embodiments of the invention are not limited to being implemented in any particular computing environment or any other environment. Accordingly, the techniques described herein may be implemented in any suitable system independent of:
Device (e.g. mobile phone vs. wired/wireless computer)
Platform (e.g. Downloadable client vs. in-browser application, etc.)
Network (e.g. Internet vs. LAN vs. mobile phone network)
Play schedule control mechanism (e.g. direct selection of tracks by users vs. voting vs. computer-based recommendation systems based on user preferences for genre, artists, new music, or positive/negative reactions to previous song).

### First Embodiment: Central Server-Assisted Simultaneous Listening

### One Detailed Implementation of the First Embodiment

In this exemplary embodiment, several users connect to a server using client programs. There is also a library of music that the clients are aware of. The users jointly create a play schedule (playlist) specifying which songs from the library should play at what times or in what order. All, most, or some of the users have ongoing input into the play schedule; they have some form of control interface that they can use to view and change the play schedule.

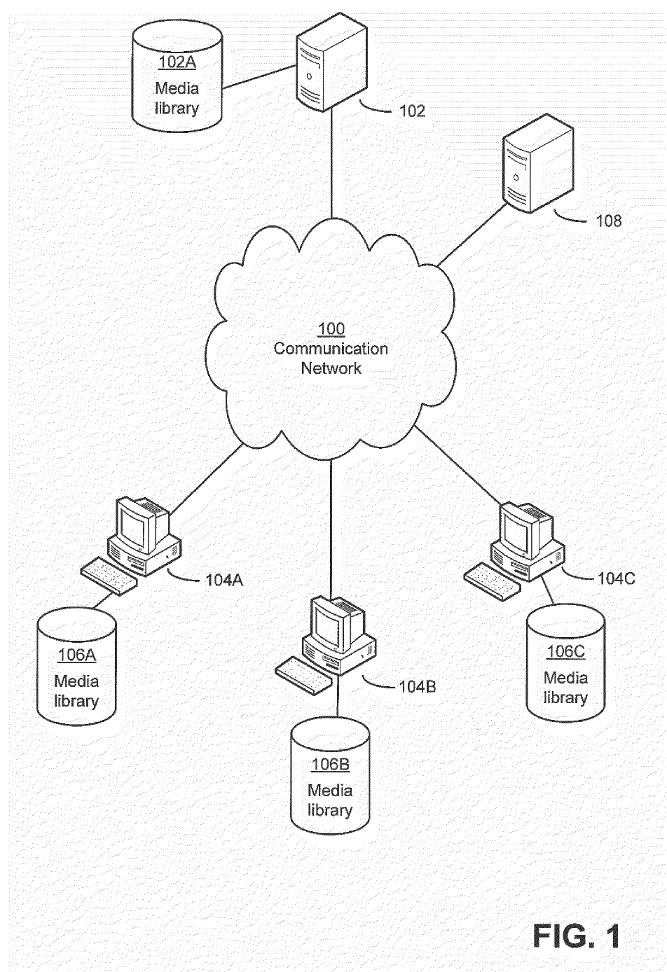

FIG. 1 shows an illustration of one exemplary computer system in which this embodiment may be implemented. In the example of FIG. 1, a communication network 100 connects a plurality of computing devices together and provides for exchange of information between them. The communication network 100 may include any suitable wired and/or wireless communication medium/media that may exchange information between two computers, such as an Ethernet wired network, an Institute of Electrical and Electronics Engineers (IEEE) 802.11 wireless network, or other suitable communication medium or media.

Connected to the communication network 100 is a library server 102, which maintains a media library 102A. The library server 102 may operate to compile a sequence of media data, based on content in the media library, and transmit it to two or more client computers 104A, 104B, and 104C for presentation. As discussed above, the library server 102 and/or clients 104 may use one or more techniques to present the sequence of media data simultaneously (or approximately simultaneously) at each of the clients, so as to create a shared media experience. For example, the library server 102 may throttle distribution of data relating to the sequence of media data to ensure that each client 104 receives data at a similar rate for presentation upon receipt. As another example, the library server 102 may create and distribute a play schedule indicating media content to be played at a particular time and distribute data relating to that media content. Each client 104 may then evaluate the play schedule to determine content to play at a particular time, and may present content at the time indicated in the play schedule while taking various steps to ensure that content is presented at the correct time and that content is presented simultaneously on each client (e.g., DAC clock drift techniques described above, or any other suitable technique). Some of these techniques may include communicating to a time server 108 to receive a correct time, such that each of the clients may be basing timing correction on a same source.

It should be appreciated that FIG. 1 is presented only for context and for ease of understanding of the description of this embodiment that is presented below. It should be appreciated that this first embodiment of the invention is not limited to operating in the environment or type of environment illustrated in FIG. 1, and may operate in other types of environments.

In this embodiment, the server creates an audio stream which it sends to the clients by retrieving audio data from the various songs in the library based on the play schedule and sending it to the clients in the specified order, but it does this assembly and sending only a little bit at a time, so as to be responsive to potential changes in the play schedule by a user. (The retrieval, though, it could do speculatively, as far ahead of time as it wants.) The clients play the audio stream, resulting in the users hearing the same thing at substantially the same time, as specified in their collaboratively created play schedule.

When one client changes the play schedule, notice of this change is sent to the other clients, causing the other users to promptly see the change on their screens (assuming that they are viewing the play schedule at the time.) Moreover, the play schedule change is immediately reflected in a change in the media data being sent to all of the clients, causing all clients to promptly hear the change that was made (if it had a bearing on what was currently playing and not just the future schedule.)

Some clients may play the stream slightly faster or slower than other clients, because the digital-to-analog converter (DAC) clocks in their sound devices run slightly faster or slower than the correct rate (or for other reasons). The server may take this into account to prevent users from drifting out of synchronization and not hearing the same thing at the same time. Any suitable techniques, including those used to maintain synchronization in Internet radio broadcasting, can be used for this purpose. This may involve the server to maintaining a central, authoritative clock, and keeping the data being sent to the client within a certain time bound based on the clock.

This approach minimizes the demands that are placed on the client program, and may, in some implementations, eliminate the need for the users to download a new, proprietary application program or browser plug-in. For example, the client can be a combination of existing software and standards, such a web browser running an AJAX application that displays the play schedule and receives the music as a standard Shoutcast “Internet radio” stream. Or, the client could be implemented as Adobe Flash application that runs within a web browser and uses Flash's existing media streaming capabilities to receive the stream. Alternatively, if a new, proprietary client is used (either as a software program or a physical device), this approach will still dramatically simplify the design and implementation of the client.

### General Description of the First Embodiment

The music library is not limited to music supplied by the operator of the server. Suppose that a user at a PC wants to play a song on his hard disk for the other users. A function could be provided that allows the song to be uploaded to the server and become part of the music library, so that that user can add it to the play schedule. In this function, the uploaded song could reside in the music library permanently (so the user can play it again later) or only temporarily (so that the song is uploaded as part of the song addition process and automatically removed when it is no longer needed by the server). The uploaded song could be accessible to other users of the service, or just the uploading user. In the example of FIG. 1 described above, the music library of each user is shown as a music library 106 (e.g., music library 106A, 106B, and 106C) connected to each of the clients 104.

Moreover, the music library might not be files physically on a file server. It can include any file the server is able to retrieve at a speed sufficiently fast to play it at the time dictated by the play schedule. For example, songs could be added to the play schedule by indicating a URL. In order to retrieve the music to assemble the stream, the server would use HTTP to retrieve that URL. In that scenario, the server could even allow the user to search or browse a directory of possible URLs to add, which could be automatically be generated with a web crawler.

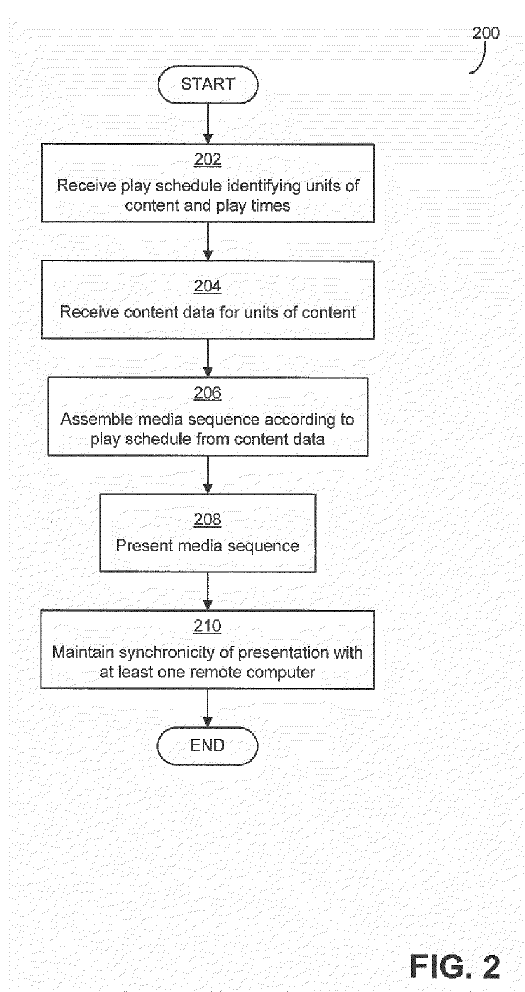

FIG. 2 shows one process 200 that may be implemented with this embodiment to carry out techniques for simultaneously presenting media content at a plurality of computers. It should be appreciated that the process 200 is merely illustrative of the types of processes that may be implemented with this embodiment of the invention, and that others are possible. Accordingly, this second embodiment of the invention is not limited to carrying out the exemplary process 200.

Process 200 begins in block 202, in which a client computer receives a play schedule identifying units of content and play times for that content. In block 204, the client computer receives content data associated with those units of content. The content data may be received in any suitable manner, including by any known technique or by any of the techniques described above.

In block 206, the client computer assembles a sequence of media content according to the play schedule by ordering the received content data according to the play times specified in the play schedule. In block 208, this media sequence is presented to a user in any suitable manner—for example, by playing audio and/or displaying video to a user, or taking any other suitable action, based on the type of media, to present the media. The media content may be presented in block 208 according to the play schedule; that is, at a particular time, the media content that is presented will be the media content specified for presentation at that time by the play schedule.

In block 210, during presentation of the sequence of media data, the client computer may take one or more actions to maintain synchronicity of presentation with at least one remote computer (i.e., at least one other client). Block 210 may implement any suitable technique, including any of the techniques described herein (e.g., DAC clock drift techniques, or other techniques). Maintaining synchronicity may, in some implementations, include communicating with one or more other computers, including a time server and/or other client computers.

Process 200 ends after simultaneous presentation of the media sequence is complete.

It should be appreciated that while process 200 of FIG. 2 is described in connection with a server, some embodiments of the invention described below may carry out a process similar to that shown in FIG. 2 that may be executed on a client computer, or on any other suitable element of a computer system.

Typically, the play schedule described in connection with FIG. 2 is a list of songs along with the times that the songs should be played, and user modify the play schedule by adding songs, removing songs, or changing the times that they should play by changing their order. But other arrangements are possible. For example, users could jointly specify the genre of music that they wish to hear, or a list of artists that they wish to hear, and songs meeting these criteria would be automatically selected, possibly according to certain restrictions, such as the playlist restrictions required for the compulsory webcasting license in the Digital Millennium Copyright Act, which requires, for example, that no more that a certain number of songs from a single album be played in a certain time period. The control actions that are taken by users could be limited in accordance with these DMCA terms, for example to changing the desired genre or artist list, indicating that a particular song is especially liked or disliked and that more or fewer songs like it should be played, and preventing or “killing” the further playback of a particular song, limited to a certain number of “kills” in a particular timeframe. Disclosure of the specific titles of upcoming titles could also be limited to comply with the DMCA terms. Combined, these restrictions could qualify the service for a compulsory copyright license under the DMCA, which may result in much lower operational costs than license available from other means.

It's easiest to have the central server maintain the play schedule, but there are other options. A client could be elected to maintain the play schedule, or it could be managed in a distributed, peer-to-peer fashion.

Words like “song” and “music” have been used, but the play schedule could instead contain video clips, or a combination of music and video content, or audio books, foreign language lessons, or lectures—any kind of media recording.

### Elements of One Illustrative Implementation According to the First Embodiment

A central server
A shared play schedule
A set of listening users
A set of control interfaces (designed for collaborative play schedule making—e.g., showing real time updates to changes in the play schedule)
50% but at least 2 of the listening users also have access to the control interface, or maybe the listening and control interfaces are integrated in some way
An assembly process running on the central server, based on the play schedule, streaming music to the listeners (Optional: not working too far ahead of current needs to maximize responsiveness to play schedule changes, with the effect that changes by a user to the play schedule are promptly reflected in what the rest of the users hear)
The users are geographically distributed rather than sitting together in one location

A clock on the server may also be used, and beyond that, client DACs with clocks and a drift compensation process for dealing with mismatch between the server clock and the client DAC clocks.

### Second Embodiment: Client-Based Simultaneous Listening

### Detailed Description of One Implementation of the Second Embodiment

In this embodiment, once again the users want to listen to music together, but instead of connecting to a central server which manages the media for them, each runs a client program.

Their client programs may have a shared time base: in other words, they have a synchronized clock that each can consult and see the same time. They may use a network time synchronization protocol such as NTP to accomplish this.

The users jointly create a shared play schedule, which may be distributed to all of the clients by some means and displayed to the users. All, some, or most of the users have ongoing control over the play schedule. When one user changes the play schedule, there is a mechanism that distributes the change to the other users, and the changes is promptly reflected on their screens.

In the shared play schedule are all of the addresses, database identifiers, URLs, credentials, passwords, or other instructions that are needed to retrieve each song at the appropriate time. The client looks at the shared clock and it looks at the play schedule; it retrieves the appropriate songs, as far ahead of their scheduled play times as may be necessary; it assembles the appropriate parts of retrieved songs into a linear stream and sends it to the sound output device.

The smart client does not have to be a downloadable program. It could be JavaScript or a Flash application running in a web browser. In the case of a JavaScript application, for example, a media player would also be embedded in the web page, and the assembly process could consist of instructing the media player to switch the remote URL that it is playing at the appropriate times. Or, if the media player supports it, the entire play schedule could be loaded into it as a playlist, as long as the schedule is then loaded again whenever it is changed.

In this embodiment, when implemented with the exemplary computer system of FIG. 1 (described above in connection with the first embodiment), the client computing devices 104 may be directly communicating with one another to exchange a play schedule and media content, rather than communicating with a library server 102. In some embodiments of the invention—such as those where the client program is a JavaScript or Flash application—a server 102 may still be present in the computer system, but may be implemented as a web server, rather than a library server.

### Techniques for Accounting for DAC Clock Drift

The sound output device is some form of DAC with a clock. This clock may run somewhat faster or slower than its nominal rate, so it may drift relative to the synchronized clock and the sound device may consume audio data faster or slower than it is supposed to. The users' DAC clocks may drift independently of one another, by as much as a few percent in some cases, so over the course of an hour what the users are hearing may become desynchronized by as much as several minutes.

It may be advantageous to correct for this drift, by monitoring the rate at which the DAC is consuming audio data and comparing it to the synchronized clock, and taking periodic corrective action. Possible corrective actions include skipping forward or backward in the audio data or inserting a bit of silence (which works well when done during a song transition, so that no “skip” is audible, but which may be done at any time), and/or resampling the audio data to a higher or lower sampling rate to match the actual rate at which the DAC is consuming samples.

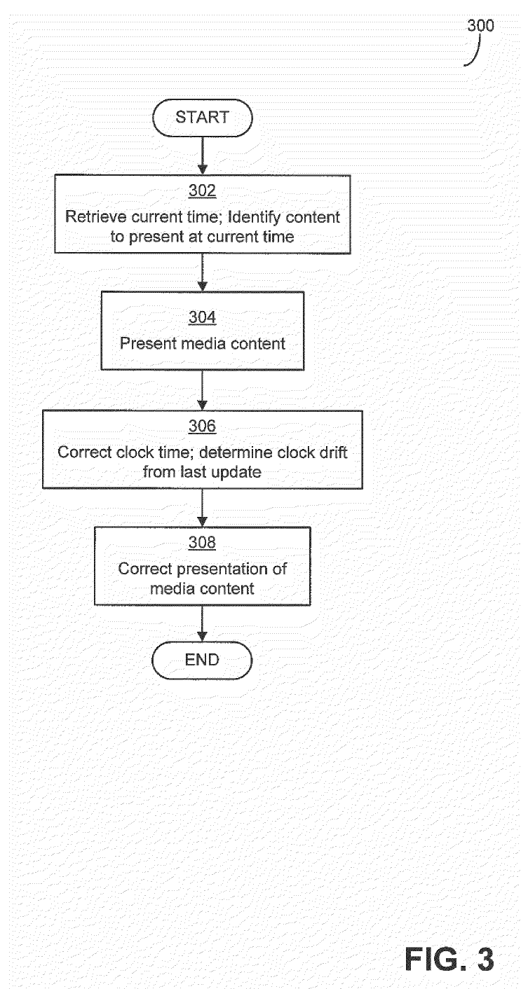

FIG. 3 shows one illustrative process 300 for maintaining synchronicity of presentation between client computers, such as by accounting for DAC clock drift on a client computer. It should be appreciated that the process 300 of FIG. 3 is merely illustrative, and that embodiments of the invention, or implementations of this embodiment, are not limited to implementing a process such as that shown in FIG. 3.

Process 300 of FIG. 3 begins in block 302, in which a current time is retrieved and used to identify media content to present at the current time. The current time may be retrieved from a source local to a client computer, such as time records for the computer. The media content to present at the current time may be identified in any suitable manner according to any suitable technique, including by examining a play schedule as described above. In block 304, the media content that was identified is presented to a user.

In block 306, a clock time may be updated by, for example, requesting a current time from a time server under the Network Time Protocol (NTP). When the clock time is updated, the difference may be calculated as a clock drift value that indicates how far out of sync the client is from the ideal presentation time. Another clock drift value may be calculated as the DAC clock drift, that specifies, as discussed above, how far out of sync the DAC clock is by consuming media data more quickly or slowly than ideal.

In block 308, the clock drift and/or DAC clock drift are used to correct presentation of media content in any suitable manner. As discussed above, this may include skipping portions of media, inserting silence, resampling media to present it more quickly or slowly for a time, or any other suitable action to ensure the media is presented at the client substantially simultaneously with other clients. Once the presentation is corrected in block 308, the process ends.

### Exemplary Process for Beginning Playback Synchronized to the Group Listening Session

Suppose a new user has just joined a listening session that is already in progress. While in some cases a user may not hear anything until a song transition, playing music for the new user playing music may alternatively begin as quickly as possible. In some implementations of this latter case, the new user's client looks at the shared play schedule and the current time and determines what song is currently playing and what time offset in the song is currently playing. Then, it retrieves the seek index for that song. The seek index is a table that relates time offsets in the song to byte offsets in the media file. Consulting the seek index, it determines the offset of the first byte that needs to be decoded in order to begin playing the song at the correct time (based ultimately on the shared time base). It then begins retrieving the song starting at that offset instead of the beginning.

The net result is that if you start listening in the middle of a song, your client begins retrieving and decoding the song in the middle of the file, rather than having to retrieve the whole file.

Sometimes, playback will fail because a needed part of a media file wasn't able to be retrieved in time. In that case, this same synchronization procedure may be performed to get playback going again. Also, if it's beneficial to skip forward or backward to account for DAC clock drift as described above, that's another case where resynchronization may be performed.

The seek index may be distributed alongside the play schedule, or may be retrieved or transmitted separately. There are ways to store the seek index efficiently by approximating it. When decoding some song file formats (including mp3), retrieval may begin a short amount of time before the desired starting play time and a certain number of samples may be discarded in order to allow the mp3 decoder to initialize certain of its components.

### General Description of the Second Embodiment

We say that the client may retrieve the remote songs, but there are ways to get that effect other than the client making a request for a song and receiving the requested data in response. For example, the remote music server could be made to receive the play schedule and participate in the clock synchronization, and then compute the appropriate media data for each client to receive, and send the data to the client with no explicit request by the client.

As in the first embodiment, there are a variety of ways to represent the play schedule, which can be maintained by a central server or in some more distributed way, and any kind of media file can be used, not just music.

A hybrid strategy in between the first embodiment and the second embodiment is possible. Everything is done just as specified in the second embodiment, but it is done server-side, and the resulting audio stream is sent to a dumb client. The second embodiment processes are carried out once per client or per group of clients. This is useful in an environment that has a mix of smart and dumb client (for example a PC-based service that also supports mobile devices). The media files may not be decoded on the server; they may be pasted together directly to make the stream, and decoded only on the dumb client; this could, in some applications, create certain synchronization issues.

There are several ways to actually implement the process described in the second embodiment, including:
Commit thread (DAC clocked). There's a buffer of samples waiting to be fed to the DAC by the operating system. They are “committed” in the sense that they will definitely play. Whenever this buffer empties below a predetermined low-watermark, a thread wakes up, determines the currently playing song and time offset, opens, closes, or seeking in the decoding session (see above under synchronization), and fills the buffer up to a high-watermark or predicted song change point and goes to sleep again.
Timer wakeup (locally clocked). The mp3 decoder works like typical prior-art music players—it decodes one song directly to the DAC and is clocked by the DAC and doesn't know anything about synchronization. But occasionally a function runs that looks at what the mp3 decoder is playing, looks at the current synchronized time, etc, and repoints the mp3 decoder to a new song or offset if necessary. The function is invoked by timer in the client that fires periodically or at estimated song transition points, and in response to play schedule changes. This strategy allows the use of a pre-existing media player software but typically results in looser synchronization. Also, if the existing media player library supports playlists, the entire play schedule can loaded into it (and updated periodically) instead of just the current song.
Server wakeup (server clocked). The server sends a simple instruction to the client: “Begin playing this sequence of songs starting at this time offset.” The client does this immediately (or at a time in the near future specified in the message.) The client doesn't necessarily attempt to perform any ongoing synchronization. When the play schedule changes, the server sends another message, and the client stops what it's doing and follows the new instructions instead. This approach is even simpler to implement: it also allows the use of an existing media player, and doesn't even require the client to consult a synchronized time base. But it results in only approximate synchronization between listeners.

There are also speculative strategies that work further in advance, assuming that the play schedule will not change. Then, on a play schedule change, the speculatively assembled audio data is thrown away and assembly is performed again on that time window based on the updated play schedule.

### Elements of One Illustrative Implementation According to this Embodiment

Multiple nodes
Shared timebase, synchronized between the nodes
Shared play schedule of multiple entries, containing pointers to media files * Means for changing the play schedule (not necessarily by the nodes) and synchronizing the changes to all nodes
Process for generating a single time-synchronized audio stream on a just-in-time basis by referencing the play schedule, retrieving the pointed-to media files (which could be from a local hard disk), and stitching them together, with ongoing reference to the shared time base (Optional: not working more than a certain amount ahead of real time so as to remain responsive to changes in the play schedule)

Additional or Alternative Concept: DAC Clock Drift Compensation
Estimating what part of what song is actually playing (coming out of the DAC) by observing the rate at which the DAC consumes the generated media stream (the DAC may be local or remote across a network)
Determining what part of what song is supposed to be playing, by consulting the shared time base and the play schedule
Comparing these two positions
Taking a corrective action if the magnitude of the difference is large enough, selected from instructing the stream generator to skip forward or backward in the stream, instructing the stream generator to insert an interval of silence, instructing the stream generator to clip the end of the currently playing track, instructing the stream generator to insert an interval of silence at the end of the currently playing track, or adaptively resampling the generated stream

Additional or Alternative Concept: Efficient Resynchronization Process
Detecting a desynchronized condition (beginning of playback, stream skipping due to media unavailability, necessity of DAC clock drift compensation)
Retrieving seek index data for a track in the play schedule without retrieving the entire media file
Consulting the shared time base and the play schedule to determine the time offset in the current song that is supposed to be playing
Using the seek index data to translating that time offset into a byte offset in the media file and a number of decoded samples n to discard, which may be zero
Beginning media retrieval at that byte offset
Beginning audio file decoding at that byte offset and discarding the first n samples decoded

### Third Embodiment: Use of Personal Music Libraries in a Simultaneous Listening System

### Detailed Description of One Exemplary Implementation of the Third Embodiment

In this embodiment, again users want to listen to music together. Assume that they have a system that makes this possible. Assume there are a great many users on the system so that each user knows only a small percentage of the other users. Among these users, there are a great many little groups listening to music together (“rooms”), not one giant room containing everyone. In fact, a given user may have the ability to join only a number of the rooms.

Each user has a personal music library, a set of music files that belong to him or are under his control. Maybe it's the music on the user's hard disk, or maybe it's music the user purchased, or uploaded to the user's online locker. The key idea is that the user has special rights to at least some of the music files in the library. It's legal for the user to listen to them, but it might not be legal for the user to post them for the general public to access.

When a user U wants to add music to the play schedule into a particular room for the group to listen to, we let U pick not just from U's own library and from music publicly available to everyone, but also allow U to browse, search, and pick from a few other libraries as well. These other libraries either (a) belong to a user associated with U (say, by being U's friend in a social network system), or (b) have been deemed to be accessible in that room (for example, the libraries of all users who have permission to listen in a room could be accessible in a room, whether they're listening at the moment or not.)

Whatever the metric, the idea is that the library owner is willing and legally able to share special rights to the music with the users the user is connected to, but not the general public.

The result is a model where a user A can cause a track from a user B's library to begin playing for a third user C, but B does not make the library accessible to the general public, only B's friends and co-participants. This has two advantages.

Superior music promotion model. In our arrangement, B contributes the song file, and A contributes an understanding of C's tastes and an awareness that C would enjoy a particular track. This makes it possible for A to introduce C to new music that A doesn't own.

In existing systems, a user X browses the library of a user Y, selects a song, and it is downloaded or streamed to user X. This is not as good, because X by definition doesn't know what unknown music in Y's library he will like. Or, in other systems, a user Y browses his own library, and selects a file and sends it to user X. This is not as good, because Y is limited to music in his personal collection. We separate the roles out into three users instead of two.

Because these techniques can be implement a simultaneous, real time system, A and C may be able to talk about the music. A can introduce the song and get immediate feedback instead of waiting for C to next log in. This is the way users already socialize and exchange information about music so it works well in practice.

Content licenses not required. Because the music is streamed instead of copied (as might be required in a non-simultaneous system), and because the music is never available to the public, but only within the normal social circle of the library owner, it's not required for the operator of the service to negotiate copyright licenses with the copyright holders on behalf of the users. This is a substantial and surprising business advantage.

### Elements of One Illustrative Implementation According to this Embodiment

A simultaneous listening system with many users and many rooms
Most users have access to only a few rooms (rooms are private spaces)
Each user is associated with a set of songs, called a music library
The user has special rights in his music library that are not shared with the general public, but can be shared with a limited number of people connected to the user
When adding music to a particular room's play schedule, a user can select from any of the music in a set of libraries.
The set of libraries is constructed such that the playing of the song in the room by the user would not constitute a public performance under copyright law. (Optional: The set of libraries is a small fraction of the total libraries on the system and is a function of the user adding the song and/or the room to which the song is being added.)

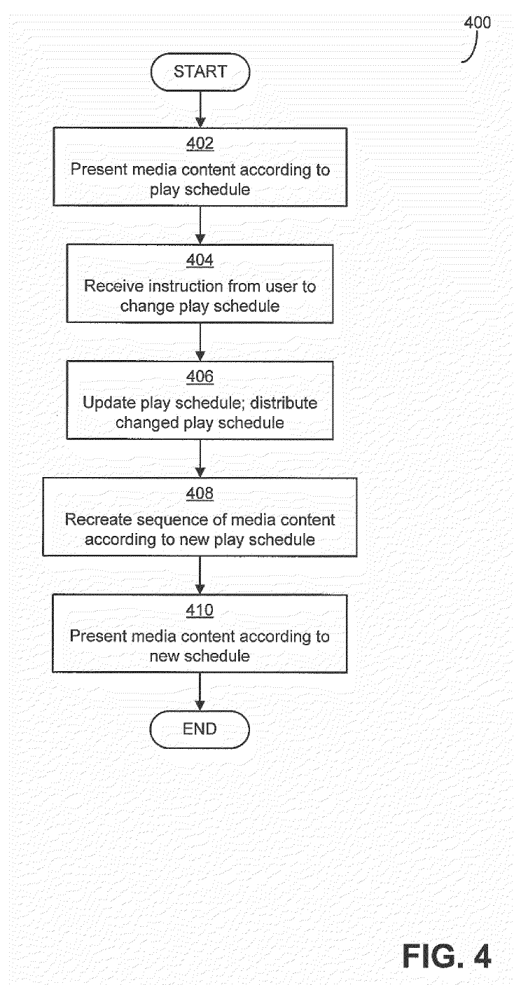

FIGS. 4-6 show flowcharts of illustrative processes that may be used with this third embodiment of the invention to share media content according to an updating play schedule. It should be appreciated, however, that embodiments of the invention are not limited to implementing the exemplary processes shown in FIGS. 4-6, and that other processes are possible.

FIG. 4 shows a process 400 for changing a play schedule according to user input and distributing that play schedule to affect simultaneous presentation of a sequence of media data on other computers. Process 400 begins in block 402, in which a sequence of media content is presented according to a play schedule using any suitable technique, including techniques described above. In block 404, instructions are received from a user to change the play schedule. For example, the instruction may request that media may be added to, removed from, or rearranged in the play schedule to change the sequence of media data that is presented according to the play schedule.

In block 406, based on the instruction received in block 404, the play schedule is updated and distributed to at least one other client computer that is engaged in a simultaneous media experience with the client computer.

In block 408, the client computer recreates a sequence of media content according to the new play schedule created in block 406, and in block 410 presents the sequence of media content according to the new play schedule. Then the process 400 ends.

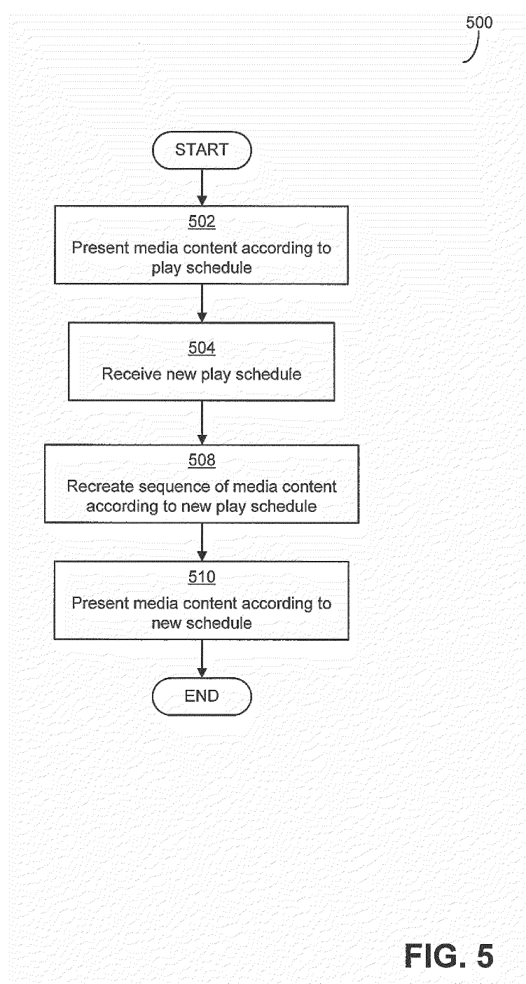

FIG. 5 shows a second process 500 for updating a sequence of media content according to an updating play schedule. Process 500 begins in block 502, in which media content is presented according to a play schedule. In block 504, a new play schedule is received specifying a different sequence of media content (e.g., different content, more content, less content, a different ordering of content, etc.).

In block 508, a client computer carrying out the process 500 creates a sequence of media content according to the new play schedule, and in block 510 the new sequence of media content is presented according to the play schedule. The process 500 then ends.

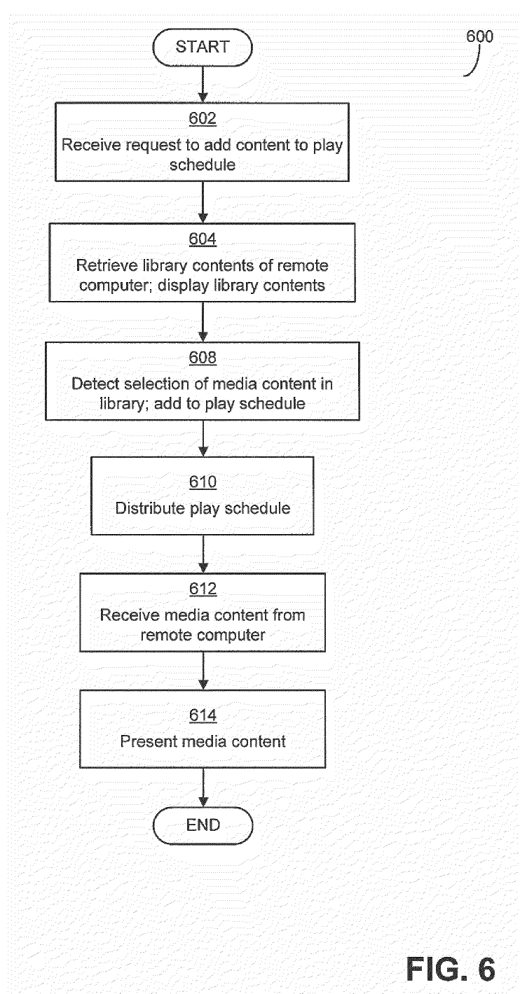

FIG. 6 shows a process 600 for adding media content to a play schedule controlling a shared media experience from a library of another user at a remote computer. Process 600 begins in block 602, in which a request to add content to the play schedule is received. In block 604, a listing of the contents of at least one media library is retrieved. The listing may be retrieved in response to a specific request—for example, a request for the media library of a particular user/computer—or may be retrieved in response to a general request for available media content that may be interpreted as a request for the media libraries of all users participating in the shared media experience.

Regardless of how the request is triggered, the listing of library contents of a remote computer is retrieved and displayed in block 604. In block 608, a selection of media content in the remote library is detected, and the media content is added to the play schedule. Once the play schedule is updated in block 608, in block 610 it may be distributed to other users/computers participating in the shared media experience.

In block 612, the client computer may receive media content from the remote computer hosting the content added to the play schedule in block 608. This may be done in any suitable manner. For example, the remote computer may have received the play schedule distributed in block 610, and may have started distributing the media content in response to receipt of the play schedule. As another example, the client computer carrying out the process 600 may have requested the media content from the client computer. Any suitable technique may be used for transferring media content between computers. In block 614, once the content is received, it may be presented according to the play schedule, at a time indicated in the play schedule, and the process 600 ends.

It should be appreciated that while the processes of FIGS. 4-6 are described in connection with particular environments (e.g., being carried out by client computers), these processes are not so limited. In some embodiments of the invention, or implementations of this embodiment, these processes may be carried out by other elements of a computer system, such as a server, either alone or in combination with client computers. For example, where FIGS. 4 and 5 describe techniques for altering a play schedule or a media sequence that are carried out by a client computer, in some embodiments of the invention these techniques may be carried out by one or more servers (e.g., the server 102 of FIG. 1) alone or in combination with one or more client computers.

### Fourth Embodiment: Use of Remote Music Libraries with Limited Uplinks

### Detailed Description of One Exemplary Implementation of the Fourth Embodiment

In this embodiment, again users want to listen to music together. Someone has added to a song to the play schedule that is stored in a remote location (call this remote location a “file server” in the general sense of a device that can serve files). This file server might not have a fast enough Internet connection to stream the song file as fast as it's needed. For example, one of the users listening might be connected by a cable modem with a slow uplink and add a high-bitrate mp3 from his hard drive.

Media transfers may be performed based on predicted future needs, rather than present needs, to maximize the use of the slow server's bandwidth and build up as much of a lead as possible before it's time for the song to begin playing.

The first and second embodiments above described an assembly function that produces an audio stream. In the first embodiment, it may be performed on a central server; in the second embodiment, it may be performed simultaneously on multiple nodes. Wherever the assembly function exists, two elements may be added parallel to it: a transfer function and a cache. The transfer function looks at the current play schedule, optionally looks at the clock, and transfers the remote files to the cache. It does this as fast as possible. Then the assembly function reads the data out of the cache at the rate that it is actually needed. Whenever the play schedule changes, the transfer function may respond by adjusting what it is transferring.

When media data is no longer needed, it may be removed from the cache, such as when they're done playing. This may be important in some applications because it prevents the content from being copied and prevents rights from being jeopardized. If licensing isn't a concern, then the media can be allowed to persist in the cache for a while on the supposition that it might be played again soon.

The transfer function first identifies the file parts that will be needed in the future but are not present in the cache. It assigns a priority to each part. It may use the priorities to construct a set of transfer commands that it passes down to the underlying transfer subsystem. Whenever the play schedule changes, it recomputes the priorities and the commands.

These techniques may use a set of heuristics and rules to compute priorities and transfer rules.

First, rather than retrieving all of the first song in the play schedule, and then all of the second song, and so on, it may be better to retrieve the immediate playback needs (say, the next 30 seconds that are scheduled to play), then the beginning of each song in the play schedule (say, the first 30 seconds of each), and then the remainder of the songs (say, all unretrieved media in the order it's scheduled to play.) This takes account the potential that the play schedule will change by loading the beginning of each song promptly, so that if it is promoted to become the currently playing song, there'll be no interruption in the stream.

Second, if there are multiple instances of the retrieval function (the second embodiment multiple assembler case), then the nodes may cooperate to avoid transferring more than one copy of any given part of the file from the file server. That may waste the file server's limited uplink by sending redundant information over it. Instead, after one copy of a part of the file has been retrieved, the nodes may exchange it among themselves, using their bandwidth instead of the file server's. This can be accomplished without central coordination by giving the file server the ability to refuse transfer requests, or by making the nodes prefer each other over the file server and inserting delays at the right places.

Dealing with Failures

If the file server's connection is sufficiently slow, or the song is scheduled to play immediately, then there may be no way to schedule transfers to satisfy the play schedule, and failure is inevitable. So the question is how we can mitigate the problem and explain it to the users.

For each upcoming song we may ask the question: If the play schedule were changed to make this the currently playing song, would it be able to play to completion without any interruptions, based on our best estimate of the uplink speed of the server hosting it? If so, we say the song is ready, otherwise we say the song is held. The held songs should be visually flagged for the users, for example by graying them out when displaying the play program.

Held songs may eventually become ready once enough of the file has been preloaded into the cache that the remainder will be able to load in time even over the slow uplink. An estimate of when a song will become ready can be computed and shown next to each held song. Ready songs can become held if network conditions change so that less bandwidth is available than estimated.

As they may not play properly, held songs should be prevented from becoming the currently playing song. This is done by having the server initiate play schedule changes in response to the hold status of the songs. Say a play schedule contains three songs that are supposed to play in order. The first song is ready and currently playing, the second song is held, and the third song is ready. After the first song finishes playing, if the second song is still held, the third song is automatically moved ahead of the second song in the play schedule, and the third song becomes the currently playing song for all users, with the second song still held.

Even though a song is ready, it may not be able to play immediately if the play schedule changes suddenly. Though it has been copied from the node with the slow uplink to other nodes with plenty of bandwidth, it might not be present in the caches of all of the listening clients yet, so a second or two might be needed to buffer it. Instead of letting the song start to play normally and causing the clients that aren't ready to miss the first few seconds of the song, the play schedule may be modified to pause playback for all listeners until the song is ready to play.

### Elements of One Illustrative Implementation According to this Embodiment

A clock
Play schedule of multiple entries, containing pointers to media files, specifying the time that each media file should play (does not have to be shared)
Servers hosting the media files
Means for changing the play schedule after it's started to play
One or more assembly point modules consisting of a cache, a transfer module, and a controller
A network connecting the media servers to the assembly point, the network being slow relative to the encoding bitrates of the media files in the play schedule
The controller periodically looks at the play schedule and the clock and generates a set of commands for the transfer module
The transfer module effects the transfer of parts of the media files from the servers where they reside to the cache
When the play schedule changes, the controller generates an updated set of commands based on the updated play schedule

It should be appreciated that a “media server” encompasses other nodes acting as relays.

In some implementations, a clock may be unnecessary, as may be the potential of changes to the play program.

Optional alternatives: Revising the play schedule to avoid trying to play held tracks
A clock
A play schedule, containing pointers to media files and the times they are supposed to play
Servers hosting the media files
At least one assembly point that follows the play schedule to retrieves the media files and stitches them together into a stream
Optionally, one or more caches where the media files can be stored temporarily Detecting a condition in which a song is about to become the currently playing song in the play schedule, but estimated rate at which the portions of the file not already in the cache will be transferred from server is below the minimum rate at which they would need to be transferred for the song to play without running out of data
In response to this condition, changing the shared play schedule (for some or all assembly points) so that some other song that does not exhibit the condition becomes the new currently playing song
   Optional additional concept: Pausing playback for all listeners for buffering
A clock
A shared play schedule made of multiple entries
Multiple assembly points that follow the play schedule to generate audio streams
Detecting a condition in which a new song is specified to begin playing in the play schedule, but more than a certain number of assembler points are in a state where they are not ready to play the song, but are predicted to be ready within a short while (e.g., five seconds)
On detecting the condition, delaying the commencement of the playback of the new song on all assemblers, not just the ones that aren't ready, and modifying the play schedule by shifting the assigned play time of each song forward into the future by an amount of time equal to the delay time

### Fifth Embodiment: Play Schedule Management

### Detailed Description of One Exemplary Implementation of the Fifth Embodiment

In some embodiments, the preferred way to represent a play schedule is as a queue. In a play schedule, there may be an ordered list of songs which play one after another without any gap between them. At any given time, the first song in the queue is playing. When it finishes playing, it is removed from the queue so that the second song becomes the first song and begins playing.

A duration may be stored for each entry in the queue, the total amount of time it's supposed to play. In addition to the list of songs, the absolute wall-clock time that the first song in the queue is supposed to start is also stored with the queue. This is sufficient to map any instant in time to the song and time offset that is supposed to be playing then.

In the queue model, songs may be removed from the schedule once they're finished playing. Contrast this with a playlist model (which may be implemented in some embodiments), where there is an ordered list of songs, and one song, not necessarily the first, is designated as playing, and when that song is finished playing, it remains in its place and the next song is designated to play. Where the queue model feels like joint control of a radio station, the playlist feels like a shared space to which music may be added. In our judgment, the queue model is a preferable experience in many applications, but other implementations may be used. Among other reasons, the queue model encourages users to add a lot of new music to the queue.

While other implementations may be used in some applications, a queue model has two advantages. First, when the queue is empty, the service may automatically add recommended music that the users might like. This is an opportunity for paid advertising. Second, adding a song to the playlist in the playlist model might conceivably be treated for copyright purposes as making a copy of the song rather than streaming it, because the song becomes available to the other users to play again and again. The queue model is more clearly streaming.

A song may, in some implementations, only be removed from the queue when it has completely finished playing. Before that point, while the song is playing, a user could insert another song before it, or move it down in the queue to play later. When that happens, the next time the song comes up the top of the queue, it will play again from the beginning. Limits may be put on this to eliminate even the theoretical possibility that users could keep a song in the queue indefinitely and play it over and over again.

### Elements of Illustrative Implementations According to this Embodiment

### Removing Songs After Play

Multiple users
Shared play queue
Means for users to manipulate the play queue
Means to make the users hear the music in the play queue simultaneously
Removing songs from the play queue when they finish playing or when they are made no longer the current song but have mostly finished playing, to prevent them from being available on an ongoing basis and being considered copies for the purpose of copyright law

### Adding Songs to Empty Queue

A music library
Detecting the condition of an empty queue or a queue that is about to become empty (for example, that contains only one song)
In response to this condition, selecting one or more songs from the library and adding them to the end of the queue
In performing the selection, taking into account the tastes and preferences of all of the users currently listening, or taking into account the estimated advertising revenue that could be earned by playing the song taking into account the demographics of the users currently listening

### Sixth Embodiment: Simultaneous Listening System with Integrated Chat Component

In embodiments which feature chat functionality, users may want to be able to see what song was playing when a particular chat message was entered, so they know which comments relate to which songs. So, we may provide a way to relate the timing of events in the chat to the play schedule. This may be rendered this as a banner that appears in chat wherever the playing song changed.

When the user logs in to a room, their chat window may be prepopulated with recent chat activity, which is possible because the server maintains a certain amount of chat history. Playing song information may therefore be integrated with the chat history somehow so that we can insert the banners in the right place in the history. This may be done by copying information about the currently playing song into every chat history database record.

### Seventh Embodiment: Simultaneous Listening System Supporting Multiple Simultaneous Sessions

In some implementations, users may be able to have multiple rooms open on their screens at once, because they want to see what all of their friends are up to, and they want an easy way to channel-surf. The client (in any format, including as a web page or a stand-alone program) may let users join multiple rooms, and may allow the users to flag one of them as listened-to. Audio may be suppressed in all but the listened-to room so the user hears only stream. The listened-to flag may then be passed up to the server and broadcast to the other participants along with room member presence information like idle time and typing activity indicators. Using this information, the client can show which users are actually listening in a room and which are just watching, which allows users to understand the social environment.

### Eighth Embodiment: Aides to Selecting Music in a Simultaneous Listening System

In some applications, when deciding which music to play, users may like to see an indication of when a given song was most recently played in a given room or heard by a given user, or how many times total that the song had been played in the room or heard by the user. In some embodiments, therefore, a client may provide recommendations to users for music to play.

Additionally or alternatively, when deciding whether to play music out of another user's library, users may want to be told whether the song will play immediately or be delayed for prebuffering (see the fourth embodiment) based on the bandwidth of the other user's connection, the bitrate of the other song, and the number of other songs that are already being played out of that library. Accordingly, in some embodiments of the invention, a client may provide warnings to users regarding music that may be selected.

### Implementation of Techniques Described Herein on One or More Computers

Techniques operating according to the principles described herein may be implemented in any suitable manner. Included in the discussion above are a series of flow charts showing illustrative acts of various processes that create a shared media experience among users at a plurality of computers. The processing and decision blocks of the flow charts above represent acts that may carry out these various processes. These processes may be implemented as software directing the operation of one or more dedicated or multi-purpose processors. It should be appreciated that the flow charts included herein do not depict the syntax or operation of any particular circuit, or of any particular programming language or type of programming language. Rather, the flow charts illustrate the functional information one of ordinary skill in the art may use to implement computer software to perform the processing of a particular apparatus carrying out the types of techniques described herein. It should also be appreciated that, unless otherwise indicated herein, the particular sequence of acts described in each flow chart is merely illustrative of the processes that may be implemented and can be varied in implementations and embodiments of the principles described herein.

Accordingly, in some embodiments, the techniques described herein may be embodied in computer-executable instructions implemented as software, including as application software or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of processes operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Functional facilities may include routines, programs, objects, components, data structures, etc. that perform particular tasks or implement particular abstract data types. The functionality of the functional facilities may be combined or distributed as desired in the systems in which they operate. In some implementations, one or more functional facilities carrying out any of the techniques described herein may together form a complete software package, for example as a software program application such as the Square Play or Cohearing applications available from Square Products Corporation.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments of the invention are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

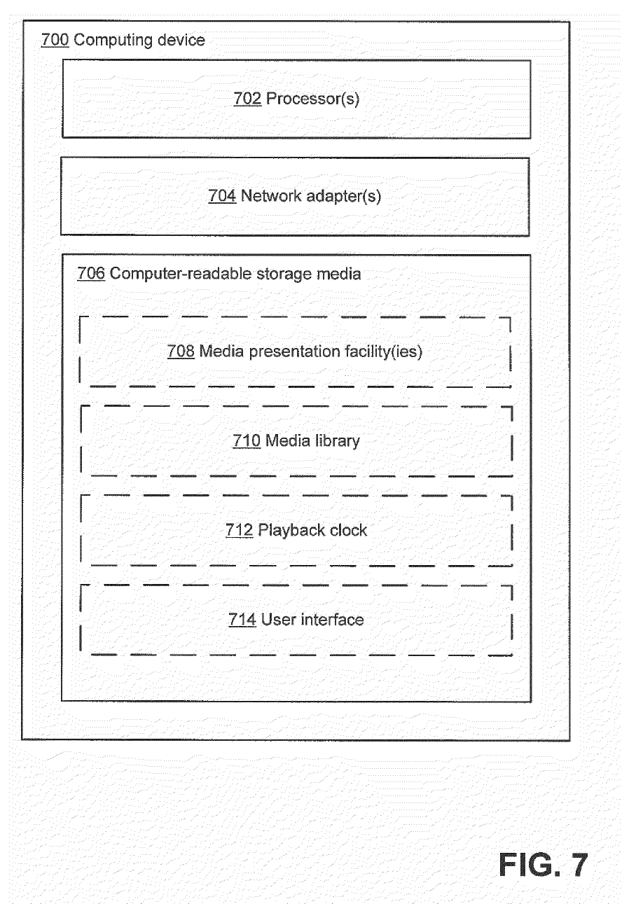

Computer-executable instructions implementing the techniques described herein (when implemented as one or more functional facilities or in any other manner) may, in some embodiments, be encoded on one or more computer-readable storage media to provide functionality to the storage media. These media may include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 706 of FIG. 7 described below (i.e., as a portion of a computing device 700) or as a stand-alone, separate storage medium. It should be appreciated that, as used herein, a “computer-readable media,” including “computer-readable storage media,” refers to tangible storage media having at least one physical property that may be altered in some way during a process of recording data thereon. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including but not limited to the exemplary computer system of FIG. 1. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 7 illustrates one exemplary implementation of a computing device in the form of a computing device 700 that may be used in a system implementing the techniques described herein, although others are possible. It should be appreciated that FIG. 7 is intended neither to be a depiction of necessary components for a computing device to operate in accordance with the principles described herein, nor a comprehensive depiction.

Computing device 700 may comprise at least one processor 702, a network adapter 704, and computer-readable storage media 706. Computing device 700 may be, for example, a desktop or laptop personal computer, a personal digital assistant (PDA), a smart mobile phone, a server, or any other suitable computing device. Network adapter 704 may be any suitable hardware and/or software to enable the computing device 700 to communicate wirelessly with any other suitable computing device over any suitable computing network. The computing network may include a wireless access point as well as any suitable wired and/or wireless communication medium or media for exchanging data between two or more computers, including the Internet. Computer-readable media 706 may be adapted to store data to be processed and/or instructions to be executed by processor 702. Processor 702 enables processing of data and execution of instructions. The data and instructions may be stored on the computer-readable storage media 706 and may, for example, enable communication between components of the computing device 700.

The data and instructions stored on computer-readable storage media 706 may comprise computer-executable instructions implementing techniques which operate according to the principles described herein. In the example of FIG. 7, computer-readable storage media 706 stores computer-executable instructions implementing various facilities and storing various information as described above. Computer-readable storage media 706 may store one or more media presentation facilities 708 to present media to a user and create a shared media experience by presenting the media substantially simultaneously with one or more remote computers also executing media presentation facilities. Media presentation facilities 708 may implement any one or more of the techniques described above for presenting media content and/or for ensuring that presentation is carried out substantially simultaneously. Computer-readable storage media 706 may further comprise a media library that may include media content units that may be presented by the media presentation facilities 708 and that may, in some implementations, be transmitted to other computing devices to be presented in the shared media experience. Computer-readable storage media 706 may further include a playback clock 712 that may maintain a time used by and updated by the media presentation facilities 708 to present media content at particular times and ensure that the content is presented at the correct time and rate. Computer-readable storage media 706 may also include one or more user interfaces 714 for the media presentation facilities 708 that may be any suitable interface for interacting with a user. In some cases, the user interface 714 may include graphical user interfaces (GUIs).

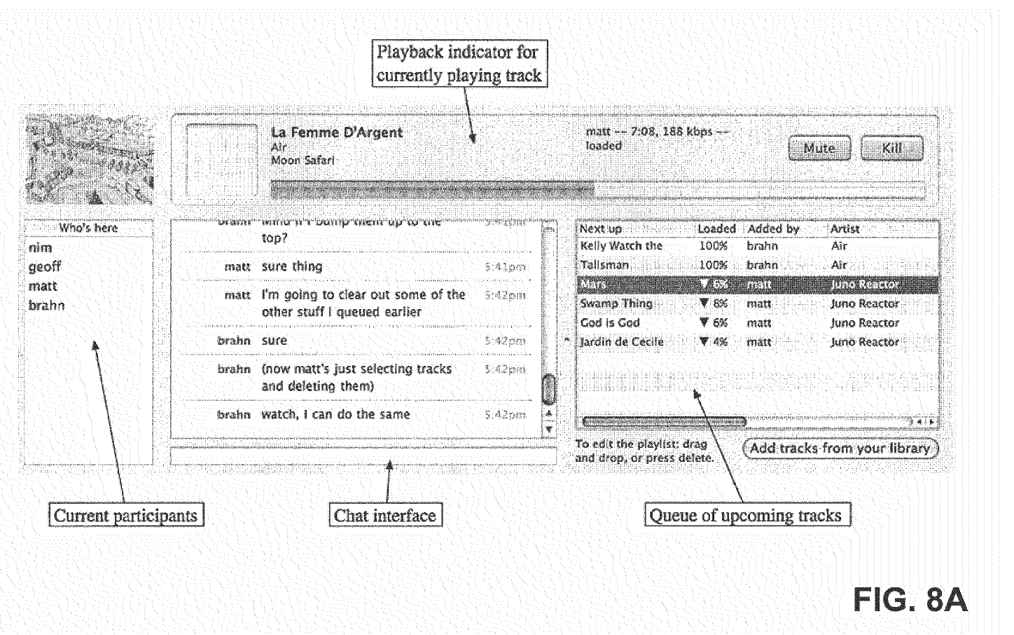

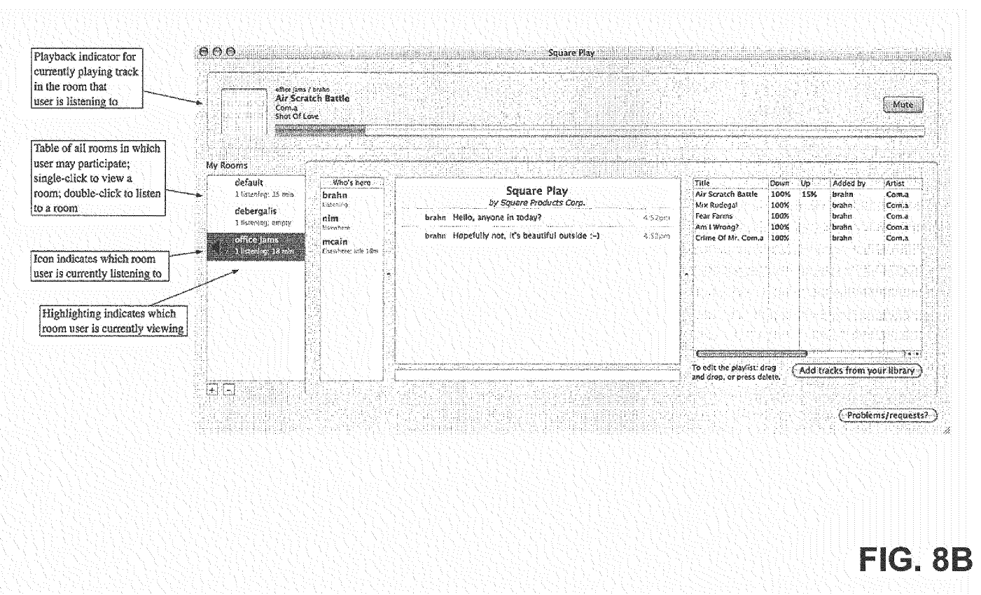

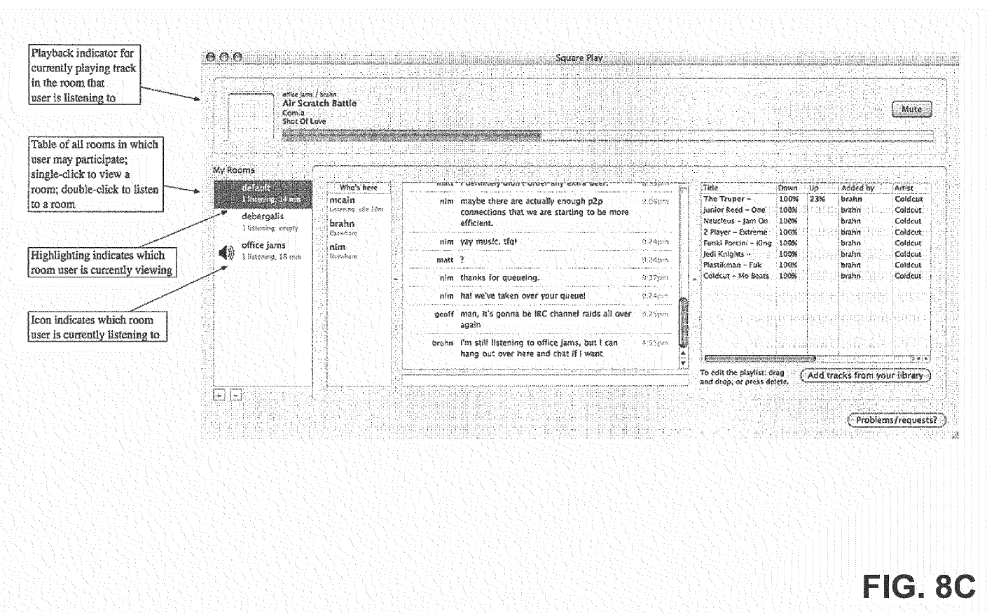

FIGS. 8A-8C show three examples of GUIs that may be implemented in some embodiments of the invention. For example, FIG. 8A shows a user interface that may be implemented when a user is engaged in one “room” in which various users are engaged in a shared media experience. The user interface of FIG. 8A may display a listing of the current participants of the shared media experience, a chat interface that permits the participants to communicate with one another, playback indicators and information on currently-presented media, and a listing of upcoming media, among other controls. FIGS. 8B and 8C show similar interfaces that may be implemented when a user is engaged in one shared media experience in one room but is “monitoring” other rooms to see what is playing and what is being discussed in the chat.

While not illustrated in FIG. 7, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the aspects of the invention described herein each may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of embodiments of the invention. Accordingly, the foregoing description and drawings are by way of example only.

1. A method of sharing media content for simultaneous presentation to users at two or more computers, the method comprising:
(A) receiving a play schedule listing a plurality of units of media content;
(B) assembling a sequence of media content according to the play schedule at each of the two or more computers; and
(C) synchronizing presentation of the sequence of media content at the two or more computers.

2. The method of claim 1, wherein synchronizing presentation of the sequence of media content comprises synchronizing playback clocks at each of the two or more computers.

3. The method of claim 2, wherein synchronizing the playback clocks comprises synchronizing the playback clocks to within one second.

4. The method of claim 2, further comprising resynchronizing the playback clocks at regular intervals.

5. The method of claim 2, wherein synchronizing the playback clocks comprises requesting a current time from a time server.

6. The method of claim 5, further comprising calculating an offset between a local time and the current time from the time server, and adjusting presentation of the play schedule based on the offset.

7. The method of claim 2, wherein assembling the sequence of media content comprises examining the play schedule and the playback clock to determine a unit of media content to play at a time.

8. The method of claim 1, further comprising:
(D) receiving an updated play schedule from one of the two or more computers.

9. The method of claim 8, further comprising assembling an updated sequence of media content in response to the updated play schedule.

10. The method of claim 1, further comprising:
(D) accepting as input from a user an instruction to make a change to the play schedule;
(E) determining an updated play schedule; and
(F) transmitting to at least one of the two or more computers the updated play schedule.

11. The method of claim 10, wherein the change is at least one of an addition, a subtraction, and a reordering of the units of media content.

12. The method of claim 1, wherein assembling the sequence of media content comprises retrieving media data from at least one of the two or more computers.

13. The method of claim 1, wherein each of the plurality of units of media content comprises at least one of audio data, video data, music data, audio book data, and slideshow data.

14. In a system comprising a plurality of users each having a library of media content, a method of facilitating shared presentation of content units among at least a subset of the plurality of users, the subset comprising first and second users, the method comprising:
(A) creating a play schedule including at least one media content unit obtained from the library of a third user; and
(B) simultaneously presenting media associated with the play schedule for the first and second users.

15. The method of claim 14, wherein the act (B) comprises simultaneously presenting the media associated with the play schedule for at least one other user.

16. The method of claim 14, wherein the act (B) comprises simultaneously presenting the media associated with the play schedule for the third user.

17. The method of claim 14, wherein the act (B) comprises simultaneously presenting the media associated with the play schedule for the plurality of users, the plurality of users comprising less than eighty users.

18. The method of claim 14, wherein the act (B) of simultaneously presenting comprises:
(C) allowing a group of users to share media data between computers associated with each of the group of users via a network without violating rights of right-holders in the content by:
(C1) bounding a size of the group of users to be a sufficiently small group not to qualify as a public performance; and
(C2) streaming media data from a computer associated with one user to computers associated with each of the other users in the group of users in a format that complicates a capture process.

19. The method of claim 18, wherein the size of the group is bounded in act (A1) to be less than 100 users.

20. The method of claim 18, wherein the membership of the group of users is limited to those being affiliated with one another in a social network.

21. At least one computer-readable storage medium encoded with computer-executable instructions that, when executed by a first computer, carry out a method of sharing media content for simultaneous presentation to a user of the first computer and a user of at least one other computer, the method comprising:
(A) receiving a play schedule listing a plurality of units of media content;
(B) assembling a sequence of media content according to the play schedule;
(C) presenting the sequence of media content at the first computer; and
(D) taking at least one act to facilitate maintaining synchronicity of presentation of the sequence with the at least one other computer.

22. The at least one computer-readable storage medium of claim 21, wherein maintaining synchronicity of the presentation of the sequence of media content comprises synchronizing playback clocks at each of the two or more computers.

23. The at least one computer-readable storage medium of claim 22, wherein synchronizing the playback clocks comprises synchronizing the playback clocks to within one second.

24. The at least one computer-readable storage medium of claim 22, wherein the method further comprises resynchronizing the playback clocks at regular intervals.

25. The at least one computer-readable storage medium of claim 22, wherein synchronizing the playback clocks comprises requesting a current time from a time server.

26. The at least one computer-readable storage medium of claim 25, further comprising calculating an offset between a local time and the current time from the time server, and adjusting presentation of the play schedule based on the offset.

27. The at least one computer-readable storage medium of claim 22, wherein assembling the sequence of media content comprises examining the play schedule and the playback clock to determine a unit of media content to play at a time.

28. The at least one computer-readable storage medium of claim 21, wherein the method further comprises:
(E) receiving an updated play schedule from one of the two or more computers.

29. The at least one computer-readable storage medium of claim 28, wherein the method further comprises assembling an updated sequence of media content in response to the updated play schedule.

30. The at least one computer-readable storage medium of claim 21, wherein the method further comprises:
(E) accepting as input from a user an instruction to make a change to the play schedule;
(F) determining an updated play schedule; and
(G) transmitting to at least one of the two or more computers the updated play schedule.

31. The at least one computer-readable storage medium of claim 30, wherein the change is at least one of an addition, a subtraction, and a reordering of the units of media content.

32. The at least one computer-readable storage medium of claim 21, wherein assembling the sequence of media content comprises retrieving media data from at least one of the two or more computers.

33. The at least one computer-readable storage medium of claim 21, wherein each of the plurality of units of media content comprises at least one of audio data, video data, music data, audio book data, and slideshow data.

34. At least one computer-readable storage medium encoded with computer-executable instructions that, when executed by a computer in a system comprising a plurality of users each having a library of media content, carry out a method of facilitating shared presentation of content units among at least a subset of the plurality of users, the subset comprising first and second users, the method comprising:
(A) creating a play schedule including at least one media content unit obtained from the library of a third user;
(B) presenting media associated with the play schedule for the first user; and
(C) during the presenting of the media associated with the play schedule, adjusting presentation of the media to the first user to facilitate presenting the media substantially synchronously with presentation of the media to a second user at a remote computer.

35. The at least one computer-readable storage medium of claim 34, wherein the act
(C) comprises simultaneously presenting the media associated with the play schedule with at least one other user.

36. The at least one computer-readable storage medium of claim 34, wherein the act
(B) comprises simultaneously presenting the media associated with the play schedule with the third user.

37. The at least one computer-readable storage medium of claim 34, wherein the act
(B) comprises simultaneously presenting the media associated with the play schedule with the plurality of users, the plurality of users comprising less than eighty users.

38. The at least one computer-readable storage medium of claim 34, wherein the act
(C) of adjusting presentation comprises:
(D) maintaining synchronous presentation between a group of users sharing media data between computers associated with each of the group of users via a network without violating rights of right-holders in the content by:
(D1) bounding a size of the group of users to be a sufficiently small group not to qualify as a public performance; and
(D2) streaming media data from a computer associated with one user to computers associated with each of the other users in the group of users in a format that complicates a capture process.

39. The at least one computer-readable storage medium of claim 38, wherein the size of the group is bounded in act (D1) to be less than 100 users.

40. The at least one computer-readable storage medium of claim 38, wherein the membership of the group of users is limited to those being affiliated with one another in a social network.

41. An apparatus for use in a computer system comprising a plurality of client computers, the apparatus being adapted to operate as a client computer to present media content synchronously with at least one other client computer, the apparatus comprising: at least one processor adapted to:
receive a play schedule listing a plurality of units of media content;
assemble a sequence of media content according to the play schedule; and
present the sequence of media content at the computer; and
taking at least one act to facilitate maintaining synchronicity of presentation of the sequence with the at least one other computer.

42. An apparatus for use in a computer system comprising a plurality of client computers each having a library of media content, the apparatus being adapted to operate as a client computer to present media content to a first user synchronously with at least one other client computer presenting the media content to a second user, the apparatus comprising: at least one processor adapted to:
create a play schedule including at least one media content unit obtained from the library of a third user of a third client computer;
present media associated with the play schedule for the first user; and
during the presenting of the media associated with the play schedule, adjust presentation of the media to the first user to facilitate presenting the media substantially synchronously with presentation of the media to a second user at a remote computer.

43-528. (canceled)
